(19) United States
(12) Patent Application Publication
(10) Pub. No.: US 2026/0172565 A1
(43) Pub. Date: Jun. 18, 2026

(54) SYSTEM AND METHOD FOR GEOMETRY POINT CLOUD CODING

(71) Applicant: GUANGDONG OPPO MOBILE TELECOMMUNICATIONS CORP., LTD., Dongguan (CN)

(72) Inventors: Vladyslav ZAKHARCHENKO, Palo Alto, CA (US); Haoping YU, Palo Alto, CA (US); Yue YU, Palo Alto, CA (US)

(21) Appl. No.: 18/879,628

(22) PCT Filed: Jul. 7, 2023
(86) PCT No.: PCT/US2023/027111

§ 371 Date: Dec. 27, 2024

Related U.S. Application Data
(60) Provisional application No. 63/367,892, filed on Jul. 7, 2022.
(60) Provisional application No. 63/368,276, filed on Jul. 13, 2022.

(51) Int. Cl. H04N 19/13; H04N 19/60

(52) U.S. Cl. CPC H04N 19/13; H04N 19/60

(57) ABSTRACT

According to one aspect of the present disclosure, a method for encoding a mesh is provided. The method may include applying, by at least one processor, mesh segmentation to a base mesh to generate a subdivided mesh. The method may include calculating, by the at least one processor, a set of mesh displacements based on the base mesh and the subdivided mesh. The method may include applying, by the at least one processor, a wavelet transform to the set of mesh displacements to generate a plurality of wavelet-transform coefficients. The method may include generating, by the at least one processor, a plurality of binarized wavelet-transform coefficients based on the plurality of wavelet-transform coefficients. The method may include encoding, by the at least one processor, the plurality of binarized wavelet-transform coefficients into a bitstream.

### CROSS-REFERENCE TO RELATED APPLICATIONS

This application is a national phase entry under 35 USC 371 of International Patent Application No. PCT/US2023/027111, filed on Jul. 7, 2023, which claims the benefit of priorities to U.S. Provisional Application No. 63/367,892, filed Jul. 7, 2022, entitled “DYNAMIC MESH GEOMETRY REFINEMENT COMPONENT EXPONENTIAL GOLOMB CODING,” and to U.S. Provisional Application No. 63/368,276, filed Jul. 13, 2022, entitled “DYNAMIC MESH GEOMETRY REFINEMENT COMPONENT WITH ENHANCED RUN LENGTH CODING,” which are incorporated by reference herein in their entireties.

### TECHNICAL FIELD

The present disclosure relates to the point cloud coding field, and more particularly, to a system and method for geometry point cloud coding.

### BACKGROUND

Point clouds are one of the major three-dimension (3D) data representations, which provide, in addition to spatial coordinates, attributes associated with the points in a 3D world. Point clouds in their raw format require a huge amount of memory for storage or bandwidth for transmission. Furthermore, the emergence of higher resolution point cloud capture technology imposes, in turn, even a higher requirement on the size of point clouds. In order to make point clouds usable, compression is necessary. Two compression technologies have been proposed for point cloud compression/coding (PCC) standardization activities: video-based PCC (V-PCC) and geometry-based PCC (G-PCC). V-PCC approach is based on 3D to two-dimensional (2D) projections, while G-PCC, on the contrary, encodes the content directly in 3D space. In order to achieve that, G-PCC utilizes data structures, such as an octree that describes the point locations in 3D space.

### SUMMARY

According to one aspect of the present disclosure, a method for encoding a mesh is provided. The method may include applying, by at least one processor, mesh segmentation to a base mesh to generate a subdivided mesh. The method may include calculating, by the at least one processor, a set of mesh displacements based on the base mesh and the subdivided mesh. The method may include applying, by the at least one processor, a wavelet transform to the set of mesh displacements to generate a plurality of wavelet-transform coefficients. The method may include generating, by the at least one processor, a plurality of binarized wavelet-transform coefficients based on the plurality of wavelet-transform coefficients. The method may include encoding, by the at least one processor, the plurality of binarized wavelet-transform coefficients into a bitstream.

According to another aspect of the present disclosure, an encoder for encoding a mesh is provided. The system may include at least one processor and memory storing instructions. The memory storing instructions, which when executed by the at least one processor, may cause the at least one processor to apply mesh segmentation to a base mesh to generate a subdivided mesh. The memory storing instructions, which when executed by the at least one processor, may cause the at least one processor to calculate a set of mesh displacements based on the base mesh and the subdivided mesh. The memory storing instructions, which when executed by the at least one processor, may cause the at least one processor to apply a wavelet transform to the set of mesh displacements to generate a plurality of wavelet-transform coefficients. The memory storing instructions, which when executed by the at least one processor, may cause the at least one processor to generate a plurality of binarized wavelet-transform coefficients based on the plurality of wavelet-transform coefficients. The memory storing instructions, which when executed by the at least one processor, may cause the at least one processor to encode the plurality of binarized wavelet-transform coefficients into a bitstream.

According to a further aspect of the present disclosure, method for decoding a mesh is provided. The method may include decoding, by at least one processor, a base mesh from a bitstream. The method may include generating, by the at least one processor, a subdivided mesh based on the base mesh. The method may include decoding, by at least one processor, a plurality of binarized wavelet-transform coefficients associated with the subdivided mesh from the bitstream. The method may include de-binarizing, by the at least one processor, the plurality of binarized wavelet-transform coefficients to generate a plurality of wavelet-transform coefficients. The method may include applying, by the at least one processor, an inverse wavelet transform to the plurality of wavelet-transform coefficients to generate a plurality of mesh displacements. The method may include generating, by the at least one processor, a reconstructed mesh based on the plurality of mesh displacements and the subdivided mesh.

According to yet a further aspect of the present disclosure, a decoder for decoding a mesh is provided. The system may include at least one processor and memory storing instructions. The memory storing instructions, which when executed by the at least one processor, may cause the at least one processor to decode a base mesh from a bitstream. The memory storing instructions, which when executed by the at least one processor, may cause the at least one processor to generate a subdivided mesh based on the base mesh. The memory storing instructions, which when executed by the at least one processor, may cause the at least one processor to decode a plurality of binarized wavelet-transform coefficients associated with the subdivided mesh from the bitstream. The memory storing instructions, which when executed by the at least one processor, may cause the at least one processor to de-binarize the plurality of binarized wavelet-transform coefficients to generate a plurality of wavelet-transform coefficients. The memory storing instructions, which when executed by the at least one processor, may cause the at least one processor to apply an inverse wavelet transform to the plurality of wavelet-transform coefficients to generate a plurality of mesh displacements. The memory storing instructions, which when executed by the at least one processor, may cause the at least one processor to generate a reconstructed mesh based on the plurality of mesh displacements and the subdivided mesh.

According to yet a further aspect of the present disclosure, a method for encoding a mesh is provided. The method may include performing, by at least one processor, mesh segmentation to generate a subdivided mesh from a base mesh. The method may include calculating, by the at least one processor, a set of mesh displacements based on the base mesh and the subdivided mesh. The method may include applying, by the at least one processor, a wavelet transform to the set of mesh displacements to generate a plurality of wavelet-transform coefficients. The method may include quantizing, by the at least one processor, the plurality of wavelet-transform coefficients to generate a plurality of quantized wavelet-transform coefficients. The method may include converting, by the at least one processor, the plurality of quantized wavelet-transform coefficients to a zero-run length code.

According to yet another aspect of the present disclosure, an encoder for encoding a mesh is provided. The system may include at least one processor and memory storing instructions. The memory storing instructions, which when executed by the at least one processor, may cause the at least one processor to perform mesh segmentation to generate a subdivided mesh from a base mesh. The memory storing instructions, which when executed by the at least one processor, may cause the at least one processor to calculate a set of mesh displacements based on the base mesh and the subdivided mesh. The memory storing instructions, which when executed by the at least one processor, may cause the at least one processor to apply a wavelet transform to the set of mesh displacements to generate a plurality of wavelet-transform coefficients. The memory storing instructions, which when executed by the at least one processor, may cause the at least one processor to quantize the plurality of wavelet-transform coefficients to generate a plurality of quantized wavelet-transform coefficients. The memory storing instructions, which when executed by the at least one processor, may cause the at least one processor to convert the plurality of quantized wavelet-transform coefficients to a zero-run length code.

According to still a further aspect of the present disclosure, a method for decoding a mesh is provided. The method may include decoding, by at least one processor, a base mesh from a bitstream. The method may include generating, by the at least one processor, a subdivided mesh based on the base mesh. The method may include decoding, by at least one processor, a plurality of binarized wavelet-transform coefficients associated with the subdivided mesh from the bitstream. The method may include decoding, by the at least one processor, at least one flag and at least one remainder associated with a zero-run length value from the bitstream using context decoding for the at least one flag and de-binarization for the at least one remainder. The method may include reconstructing, by the at least one processor, at least one first wavelet-transform coefficient associated with a set of mesh displacements and at least one second wavelet-transform coefficient associated with the zero-run length value based on the at least one flag and the at least one remainder. The method may include applying, by the at least one processor, an inverse wavelet transform to at least one first wavelet-transform coefficient to generate the set of mesh displacements. The method may include generating, by the at least one processor, a reconstructed mesh based on the set of mesh displacements and the subdivided mesh.

According to still another aspect of the present disclosure, a decoder for decoding a mesh is provided. The system may include at least one processor and memory storing instructions. The memory storing instructions, which when executed by the at least one processor, may cause the at least one processor to decode a base mesh from a bitstream. The memory storing instructions, which when executed by the at least one processor, may cause the at least one processor to generate a subdivided mesh based on the base mesh. The memory storing instructions, which when executed by the at least one processor, may cause the at least one processor to decode a plurality of binarized wavelet-transform coefficients associated with the subdivided mesh from the bitstream. The memory storing instructions, which when executed by the at least one processor, may cause the at least one processor to decode at least one flag and at least one remainder associated with a zero-run length value from the bitstream using context decoding for the at least one flag and de-binarization for the at least one remainder. The memory storing instructions, which when executed by the at least one processor, may cause the at least one processor to reconstruct at least one first wavelet-transform coefficient associated with a set of mesh displacements and at least one second wavelet-transform coefficient associated with the zero-run length value based on the at least one flag and the at least one remainder. The memory storing instructions, which when executed by the at least one processor, may cause the at least one processor to apply an inverse wavelet transform to at least one first wavelet-transform coefficient to generate the set of mesh displacements. The memory storing instructions, which when executed by the at least one processor, may cause the at least one processor to generate a reconstructed mesh based on the set of mesh displacements and the subdivided mesh.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates a block diagram of a geometry-coding process implemented by an encoder, according to some embodiments of the present disclosure.

FIGS. 6A-6C illustrates a mesh subdivision and mesh displacement approximation process implemented by an encoder, according to some embodiments of the present disclosure.

FIG. 7 illustrates a detailed diagram of a parametrized mesh-coding process, according to some embodiments of the present disclosure.

FIG. 8 illustrates a diagram of a mesh data structure, according to some embodiments of the present disclosure.

FIG. 9 illustrates a diagram of a mesh with four vertices and three triangular faces, according to some embodiments of the present disclosure.

FIG. 10 illustrates a connectivity diagram of a mesh with four vertices and three triangular faces, according to some embodiments of the present disclosure.

FIG. 11 illustrates a data structure diagram for a parametrized mesh, according to some embodiments of the present disclosure.

FIG. 12 illustrates a diagram of a mesh with four vertices and three triangular faces and a corresponding attribute map, according to some embodiments of the present disclosure.

FIG. 13 illustrates a diagram of mesh-face orientation based on vertex-index order, according to some embodiments of the present disclosure.

FIG. 14 illustrates a detailed diagram of an exemplary encoder architecture for parametrized mesh coding with exp-Golomb displacements coding, according to some embodiments of the present disclosure.

FIG. 15A illustrates a diagram of an example mesh-coding process timing diagram, according to some embodiments of the present disclosure.

FIG. 15B illustrates a diagram of an exemplary mesh-coding process timing diagram, according to some embodiments of the present disclosure.

FIG. 16A illustrates an exemplary binarization and entropy encoding flow diagram for quantized wavelet-transform coefficients, according to some embodiments of the present disclosure.

FIG. 16B illustrates an exponential-Golomb-k coding examples, according to some embodiments of the present disclosure.

FIG. 17 illustrates a detailed diagram of an exemplary encoder architecture for parametrized mesh coding with zero run-length displacements coding, according to some embodiments of the present disclosure.

FIG. 18 illustrates an exemplary zero-run length coding flow diagram for quantized coefficients, according to some embodiments of the present disclosure.

FIGS. 19A-19C illustrate an exemplary zero-run length value coding flow diagram, according to some embodiments of the present disclosure.

FIG. 20 illustrates a flowchart for a first exemplary mesh-encoding technique, according to some embodiments of the present disclosure.

FIG. 21 illustrates a flowchart for a first mesh-decoding technique, according to some embodiments of the present disclosure.

FIG. 22 illustrates a flowchart for a first exemplary mesh-encoding technique, according to some embodiments of the present disclosure.

FIG. 23 illustrates a flowchart for a first mesh-decoding technique, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of point cloud coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system. The techniques described herein may be used for various point cloud coding applications. As described herein, point cloud coding includes both encoding and decoding a point cloud.

A point cloud is composed of a collection of points in a 3D space. Each point in the 3D space is associated with a geometry position together with the associated attribute information (e.g., color, reflectance, intensity, classification, etc.). In order to compress the point cloud data efficiently, the geometry of a point cloud can be compressed first, and then the corresponding attributes, including color or reflectance, can be compressed based upon the geometry information according to a point cloud coding technique, such as G-PCC. G-PCC has been widely used in virtual reality/augmented reality (VR/AR), telecommunication, autonomous vehicle, etc., for entertainment and industrial applications, e.g., light detection and ranging (LiDAR) sweep compression for automotive or robotics and high-definition (HD) map for navigation. Moving Picture Experts Group (MPEG) released the first version G-PCC standard, and Audio Video Coding Standard (AVS) is also developing a G-PCC standard.

The existing G-PCC standards, however, cannot work well for a wide range of PCC inputs for many different applications. For example, besides the representation of levels (or coefficients in some cases), the representation of other information (e.g., parameters) used for G-PCC may be coded in the forms of syntax elements in the bitstream as well. Since G-PCC is organized in different levels by dividing a collection of points into different pieces (e.g., sequence, slices, etc.) associated with different properties (e.g., geometry, attributes, etc.), the parameter sets are also arranged in different levels (e.g., sequence-level, property-level, slice-level, etc.), for example, in the different headers. Moreover, multiple condition checks may be required for parsing some syntax elements in G-PCC, which further increases the complexity of organizing and parsing the representation of syntax elements.

To improve the flexibility and generality of point cloud coding, the present disclosure provides various novel schemes of syntax element representation and organization, which are compatible with any suitable G-PCC standards, including, but not limited to, AVS G-PCC standards and MPEG G-PCC standards.

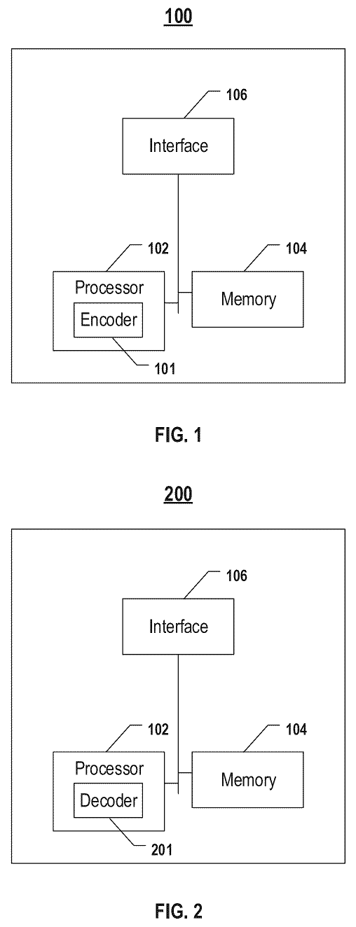

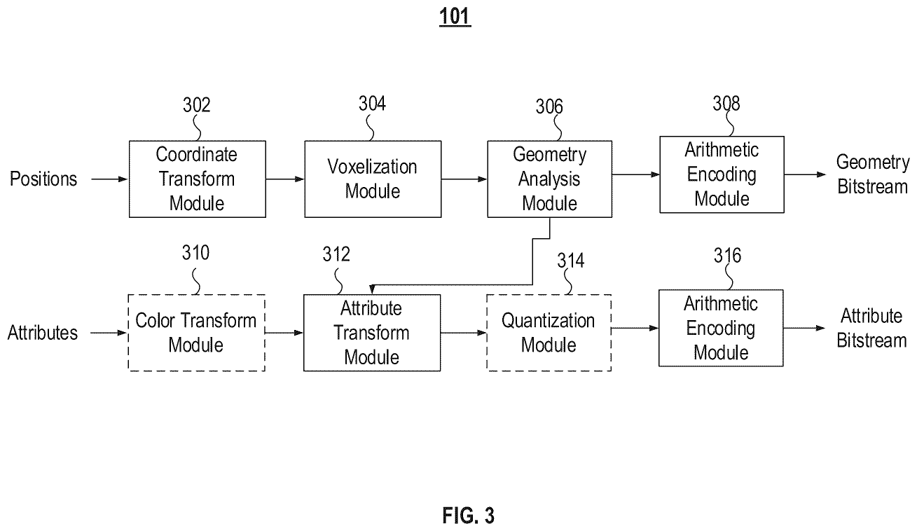

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatuses capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected one to another by a bus, but other connection types are also permitted. It is understood that system 100 or 200 may include any other suitable components for performing functions described here.

Processor 102 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing point cloud coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running point cloud encoding and decoding applications. In another example, processor 102, memory 104, and interface 106 may be integrated on a specialized processor chip for point cloud coding, such as a GPU or ISP chip dedicated to graphic processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to point cloud encoding, such as voxelization, transformation, quantization, arithmetic encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to point cloud decoding, such as arithmetic decoding, dequantization, inverse transformation, reconstruction, synthesis, as described below in detail.

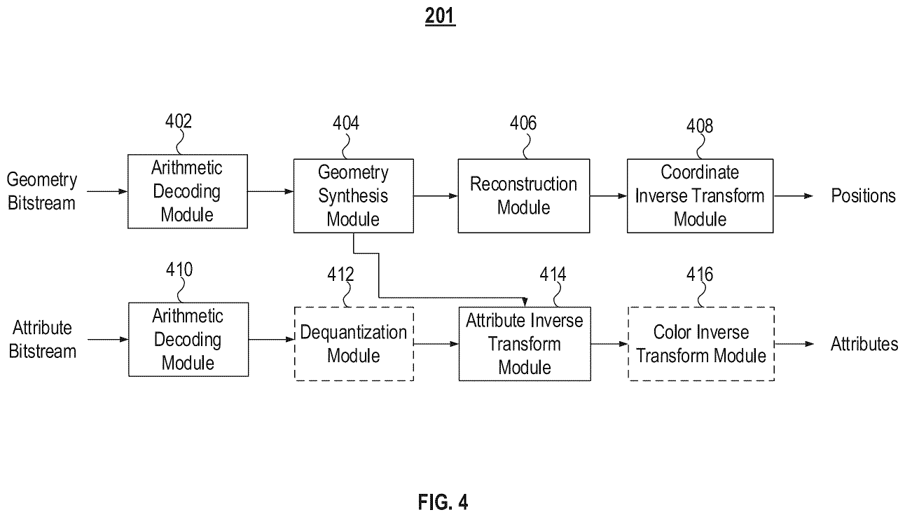

FIG. 3 illustrates a detailed block diagram of exemplary encoder 101 in encoding system 100 in FIG. 1, according to some embodiments of the present disclosure. As shown in FIG. 3, encoder 101 may include a coordinate transform module 302, a voxelization module 304, a geometry analysis module 306, and an arithmetic encoding module 308, together configured to encode positions associated with points of a point cloud into a geometry bitstream (i.e., geometry encoding). As shown in FIG. 3, encoder 101 may also include a color transform module 310, an attribute transform module 312, a quantization module 314, and an arithmetic encoding module 316, together configured to encode attributes associated with points of a point cloud into an attribute bitstream (i.e., attribute encoding). It is understood that each of the elements shown in FIG. 3 is independently shown to represent characteristic functions different from each other in a point cloud encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101. It is still further understood that the modules shown in FIG. 3 are for illustrative purposes only, and in some examples, different modules may be included in encoder 101 for point cloud encoding.

As shown in FIG. 3, geometry positions and attributes associated with points may be encoded separately. A point cloud may be a collection of points with positions Xₖ=(xₖ, yₖ, zₖ), k=1, . . . , K, where K is the number of points in the point cloud, and attributes Aₖ=(A₁ₖ, A₂ₖ, . . . , A_{Dk}), k=1, . . . , K, where D is the number of attributes for each point. In some embodiments, attribute coding depends on decoded geometry. As a consequence, point cloud positions may be coded first. Since geometry positions may be represented by floating-point numbers in an original coordinate system, coordinate transform module 302 and a voxelization module 304 may be configured to perform a coordinate transformation followed by voxelization that quantizes and removes duplicate points. The process of position quantization, duplicate point removal, and assignment of attributes to the remaining points is called voxelization. The voxelized point cloud may be represented using, for example, an octree structure in a lossless manner. Geometry analysis module 306 may be configured to perform geometry analysis using, for example, the octree or trisoup scheme. Arithmetic encoding module 308 may be configured to arithmetically encode the resulting structure from geometry analysis module 306 into the geometry bitstream.

In some embodiments, geometry analysis module 306 is configured to perform geometry analysis using the octree scheme. Under the octree scheme, a cubical axis-aligned bounding box B may be defined by the two extreme points (0,0,0) and (2^{d}, 2^{d}, 2^{d}) where d is the maximum size of the given point cloud along the x, y, or z direction. All point cloud points may be included in this defined cube. A cube may be divided into eight sub-cubes, which creates the octree structure allowing one parent to have 8 children, and an octree structure may then be built by recursively subdividing sub-cubes. An 8-bit code may be generated by associating a 1-bit value with each sub-cube to indicate whether it contains points (i.e., full and has value 1) or not (i.e., empty and has value 0). Only full sub-cubes with a size greater than 1 (i.e., non-voxels) may be further subdivided. The geometry information (x, y, z) for one position may be represented by this defined octree structure. Since points may be duplicated, multiple points may be mapped to the same sub-cube of size 1 (i.e., the same voxel). In order to handle such a situation, the number of points for each sub-cube of dimension 1 is also arithmetically encoded. By construction of the octree, a current cube associated with a current node may be surrounded by six cubes of the same depth sharing a face with it. Depending on the location of the current cube, one cube may have up to six same-sized cubes to share one face. In addition, the current cube may also have some neighboring cubes which share lines or points with the current cube.

Referring back to FIG. 3, as to attribute encoding, optionally, color transform module 310 may be configured to convert red/green/blue (RGB) color attributes of each point to YCbCr color attributes if the attributes include color. Attribute transform module 312 may be configured to perform attribute transformation based on the results from geometry analysis module 306 (e.g., using the octree scheme), including but not limited to, the region adaptive hierarchical transform (RAHT), interpolation-based hierarchical nearest-neighbor prediction (predicting transform), and interpolation-based hierarchical nearest-neighbor prediction with an update/lifting step (lifting transform). Optionally, quantization module 314 may be configured to quantize the transformed coefficients of attributes from attribute transform module 312 to generate quantization levels of the attributes associated with each point to reduce the dynamic range. Arithmetic encoding module 316 may be configured to arithmetically encode the resulting transformed coefficients of attributes associated with each point or the quantization levels thereof into the attribute bitstream.

In some embodiments, a prediction may be formed from neighboring coded attributes, for example, in predicting transform and lifting transform by attribute transform module 312. Then, the difference between the current attribute and the prediction may be coded. According to some aspects of the present disclosure, in the AVS G-PCC standard, after the geometry positions are coded, a Morton code or Hilbert code may be used to convert a point cloud in a 3D space (e.g., a point cloud cube) into a 1D array. Each position in the cube will have a corresponding Morton or Hilbert code, but some positions may not have any corresponding point cloud attribute. In other words, some positions may be empty. The attribute coding may follow the predefined Morton order or Hilbert order. A predictor may be generated from the previous coded points in the 1D array following the Morton order or Hilbert order. The attribute difference between the current point and its prediction points may be encoded into the bitstream. In some embodiments, the point cloud in the 3D space (e.g., a point cloud cube) is converted into a 1D array without any pre-defined order, but instead in its native input order, for example, the order in which the point cloud data is collected. That is, in some examples, the attribute coding may follow the native input order of the point cloud, instead of the predefined Morton order or Hilbert order. In other words, the order followed by the points in the 1D array may be either a Morton order, a Hilbert order, or the native input order.

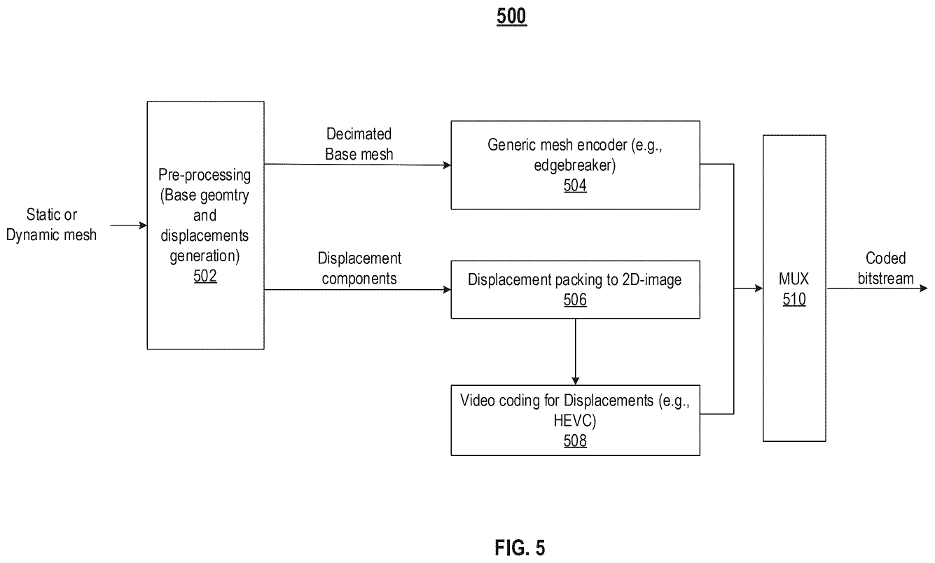

FIG. 4 illustrates a detailed block diagram of exemplary decoder 201 in decoding system 200 in FIG. 2, according to some embodiments of the present disclosure. As shown in FIG. 4, decoder 201 may include an arithmetic decoding module 402, a geometry synthesis module 404, a reconstruction module 406, and a coordinate inverse transform module 408, together configured to decode positions associated with points of a point cloud from the geometry bitstream (i.e., geometry decoding). As shown in FIG. 4, decoder 201 may also include an arithmetic decoding module 410, a dequantization module 412, an attribute inverse transform module 414, and a color inverse transform module 416, together configured to decode attributes associated with points of a point cloud from the attribute bitstream (i.e., attribute decoding). It is understood that each of the elements shown in FIG. 4 is independently shown to represent characteristic functions different from each other in a point cloud decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201. It is still further understood that the modules shown in FIG. 4 are for illustrative purposes only, and in some examples, different modules may be included in decoder 201 for point cloud decoding.

When a point cloud bitstream (e.g., a geometry bitstream or an attribute bitstream) is input from a point cloud encoder (e.g., encoder 101), the input bitstream may be decoded by decoder 201 in a procedure opposite to that of the point cloud encoder. Thus, the details of decoding that are described above with respect to encoding may be skipped for ease of description. Arithmetic decoding modules 402 and 410 may be configured to decode the geometry bitstream and attribute bitstream, respectively, to obtain various information encoded into the bitstream. For example, arithmetic decoding module 410 may decode the attribute bitstream to obtain the attribute information associated with each point, such as the quantization levels or the coefficients of the attributes associated with each point. Optionally, dequantization module 412 may be configured to dequantize the quantization levels of attributes associated with each point to obtain the coefficients of attributes associated with each point. Besides the attribute information, arithmetic decoding module 410 may parse the bitstream to obtain various other information (e.g., in the form of syntax elements), such as the syntax element indicative of the order followed by the points in the 1D array for attribute coding.

Inverse attribute transform module 414 may be configured to perform inverse attribute transformation, such as inverse RAHT, inverse predicting transform, or inverse lifting transform, to transform the data from the transform domain (e.g., coefficients) back to the attribute domain (e.g., luma and/or chroma information for color attributes). Optionally, color inverse transform module 416 may be configured to convert YCbCr color attributes to RGB color attributes.

As to the geometry decoding, geometry synthesis module 404, reconstruction module 406, and coordinate inverse transform module 408 of decoder 201 may be configured to perform the inverse operations of geometry analysis module 306, voxelization module 304, and coordinate transform module 302 of encoder 101, respectively.

Consistent with the scope of the present disclosure, encoder 101 and decoder 201 may be configured to adopt various novel schemes of syntax element representation and organization, as disclosed herein, to improve the flexibility and generality of point cloud coding.

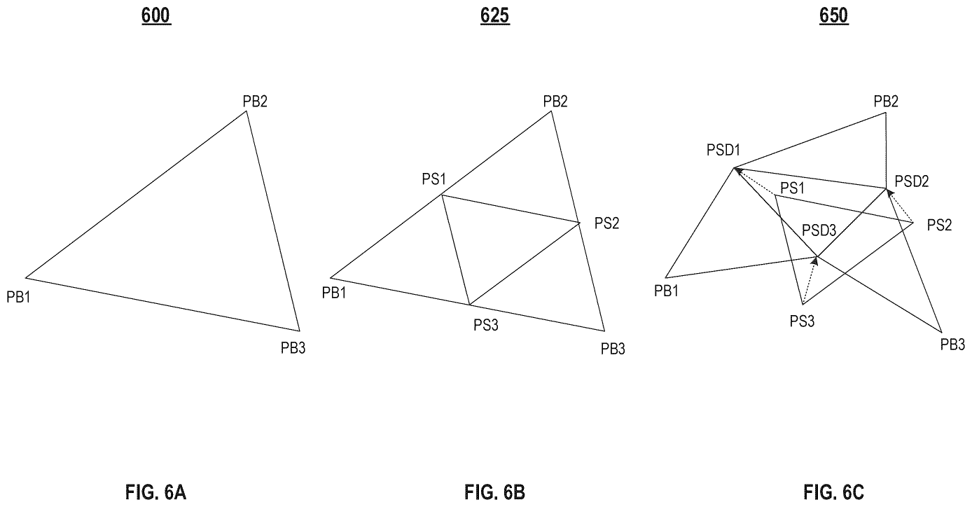

Some existing techniques apply a two-stage encoding procedure to encode geometry information. First, the geometry is decimated to create a base mesh encoded using generic geometry-coding method, e.g., “edgebreaker.” Then, the base mesh is hierarchically subdivided, and the difference between the subdivided point and the approximation of the original mesh is stored as the geometry displacements component. The displacement components are packed into a two-dimensional (2D) image and encoded with lossless video coding. A high-level diagram of the two-stage geometry-coding process 500 is described below in connection with FIG. 5.

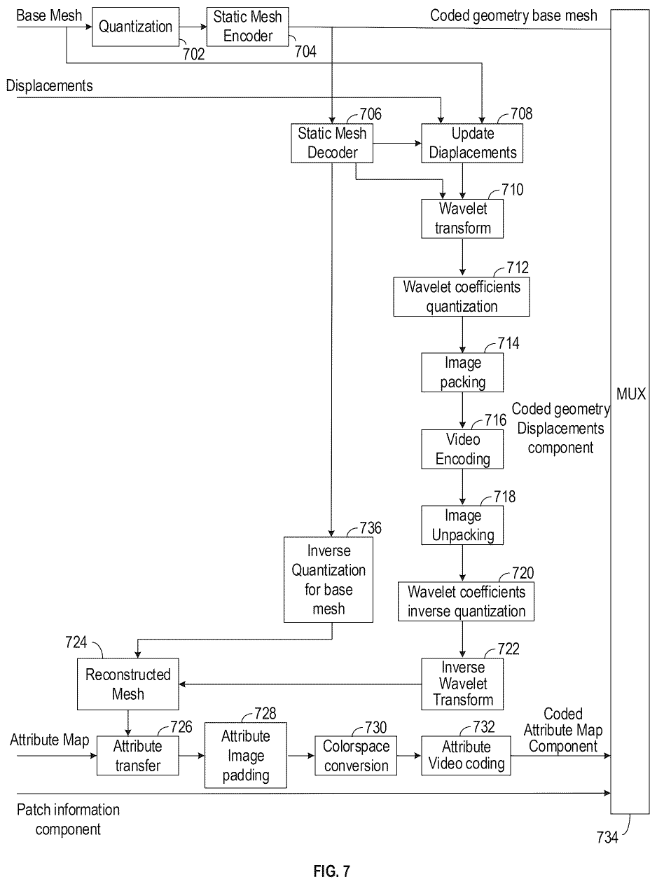

Referring to FIG. 5, an encoder may receive a static or dynamic mesh of a video, picture, frame, scene, etc. At 502, the encoder may perform pre-processing to generate a base-mesh geometry and mesh displacements. The base-mesh geometry may include a decimated base mesh with a fewer number of points than the static or dynamic mesh that was originally received. The decimated base mesh may be input to a mesh encoder 504 that implements, e.g., an edgebreaker encoding process. The mesh encoder may perform geometry encoding of the decimated base mesh. On the other hand, the mesh displacements may be input to a displacements-packing component 506. The displacements-packing component 506 may perform displacements packing to a 2D image, as described below in connection with FIGS. 6A-6C. The displacements packing information may be input to a video coder 508 for displacements, e.g., such as an HEVC component. Mesh encoder 504 and video coder 508 may input their respective information to a multiplexer (MUX) 510, which encodes the information into a bitstream.

FIGS. 6A-6C illustrates a mesh subdivision and mesh displacement approximation process 600, 625, 650 implemented by a displacements-packing component of an encoder, according to some embodiments of the present disclosure. In FIGS. 6A-6C, this process is illustrated for once face in a base mesh.

Referring to FIG. 6A, PB1, PB2, and PB3 denote the base mesh points. PS1, PS2, and PS3, in FIG. 6B, represent subdivided points. PSD1, PSD2, and PSD3 represent subdivided displaced points, as shown in FIG. 6C. Subdivided point PS1 may be calculated as a mid-point between the PB1 and PB2 points. Then, the process can be recursively repeated. Each vector of PS1 and PSD1 is described as three components in normal, tangent, and bitangent directions that are further mapped to color planes (e.g., Y, U, and V components in YUV 444 color space).

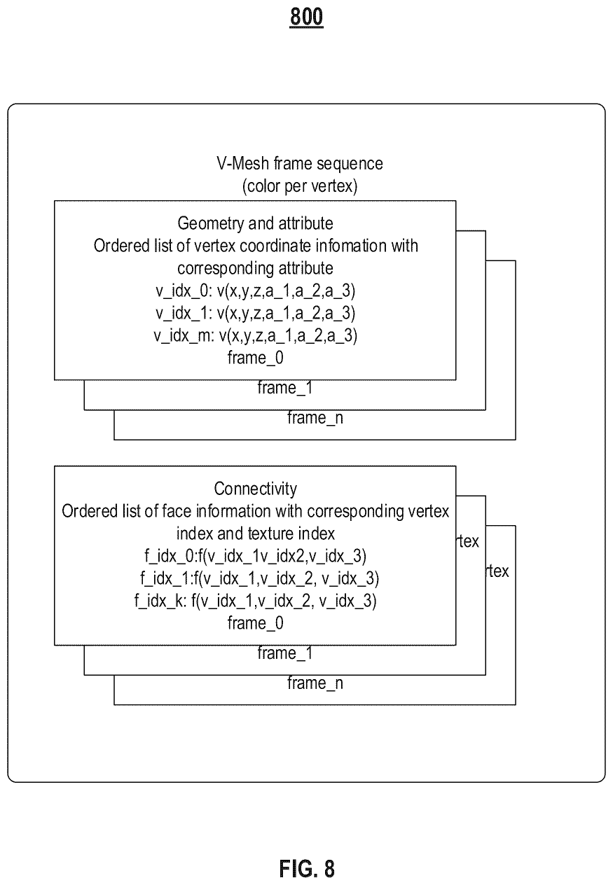

FIG. 7 illustrates a detailed diagram of a parametrized mesh-coding process 700, according to some embodiments of the present disclosure. Referring to FIG. 7, the base mesh frame is quantized by a quantization component 702 and encoded using a static mesh encoder 704. The process is agnostic to the type of mesh encoding scheme used to compress the base mesh.

Mesh displacements may be input to an update-displacements component 708, which updates the displacements based on information received from static mesh decoder 706. This information may be related to the decimated base mesh, for example. Once updated, the mesh displacements may be input to a wavelet-transform component 710. For instance, the mesh displacements may be processed using a hierarchical wavelet transform (or another type of transform) that recursively applies refinement layers to the reconstructed base mesh. The wavelet-transform coefficients are then quantized by wavelet-coefficient quantization component 712. Then, image-packing component 714 may pack the quantized wavelet-transform coefficients into a 2D image/video, which is compressed using a traditional image/video encoder 716.

The reconstructed version of the wavelet-transform coefficients may be generated by image unpacking component 718, which applies image unpacking. Wavelet-coefficient inverse quantization component 720 may perform inverse quantization to the reconstructed wavelet coefficient image/video generated during the image/video decoding process. Reconstructed displacements are then computed by applying the inverse wavelet transform to the reconstructed wavelet by inverse wavelet-transform component 722. The reconstructed wavelet-transform coefficients are input to the reconstructed mesh component 724, along with an inverse quantization of the base mesh from inverse quantization for base mesh component 736. Once the mesh is reconstructed, it may be input to an attribute transfer component 726, along with a preconstructed attribute map. Once the attributes are transferred to the reconstructed mesh, an attribute image padding component 728 may apply image padding to the reconstructed mesh, along with an attribute transfer. Colorspace conversion 730 may perform a color space conversion for the attribute map. Then, attribute video-coding component 732 may encode the attribute map. The coded attribute map, patch information, and the coded-geometry base-mesh may be input to multiplexer 734 for input to a bitstream.

Wavelet-transform coefficients are calculated in a floating-point format and can be positive and/or negative. In existing techniques, the coefficients are first converted to positive values and mapped to a given bit-depth to generate a 2D image, using expression (1).

$${c}^{′} ( i ) = 2 \hat{} [ bit\_depth - 1 ] + [ c ( i ) * 2 \hat{} bit\_depth ] / [ c\_max - c\_min ] , \qquad ( 1 )$$

where c′(i) is an integerized displacement coefficient value, c (i) is a current displacement coefficient, c_max is a maximum displacement coefficient value, c_min is a minimum displacement coefficient value, and bit_depth is a value that defines a number of fixed levels for image coding.

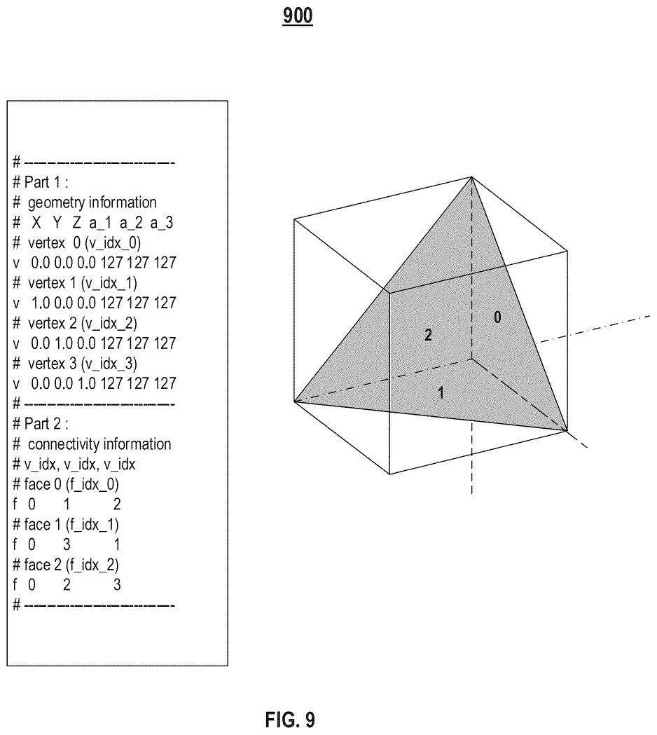

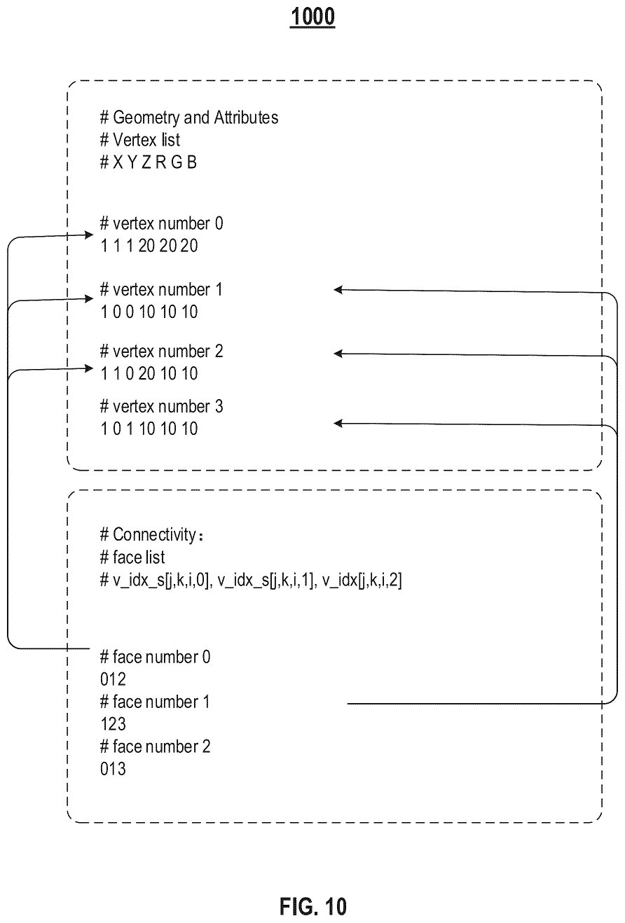

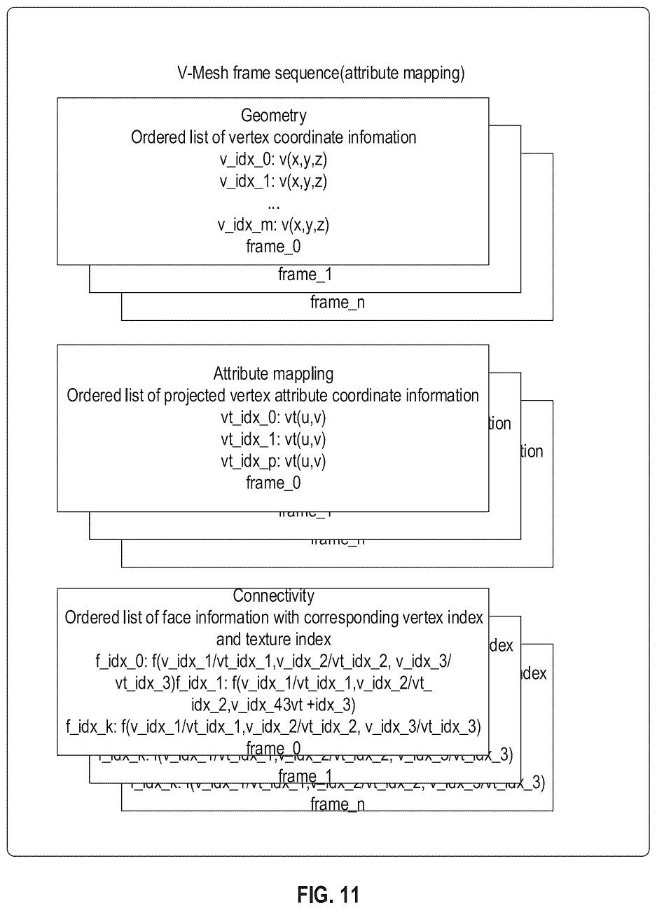

An example of geometry information for one mesh frame is depicted in the mesh data structure 800 illustrated in FIG. 8. FIG. 9 illustrates a diagram 900 of a mesh with four vertices and three triangular faces, according to some embodiments of the present disclosure. FIG. 10 illustrates a connectivity diagram 1000 of a mesh with four vertices and three triangular faces, according to some embodiments of the present disclosure.

Referring to FIG. 9, an example of a surface, represented by a mesh with color-per-vertex characteristics, four vertices, and three faces. A position in space describes each vertex by X, Y, Z coordinates and color attributes red (R), green (G), and blue (B). As shown in FIG. 9, each face is defined by three vertex indices that form a triangle. A connectivity diagram of these features is illustrated in FIG. 10.

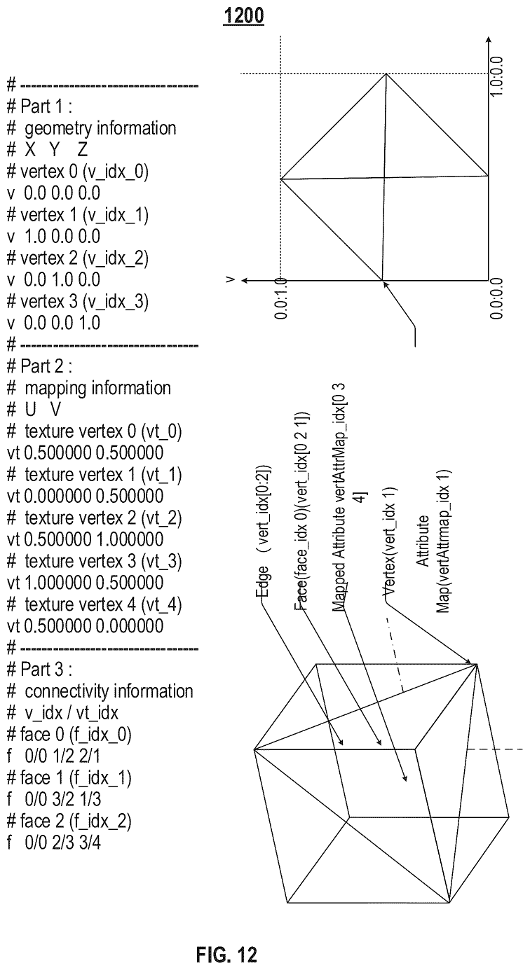

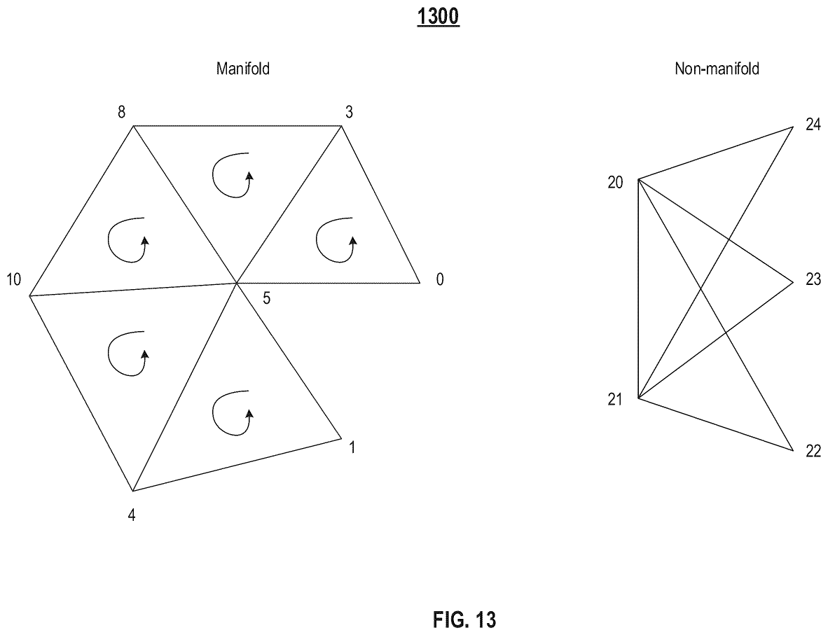

FIG. 11 illustrates a data structure diagram 1100 for a parametrized mesh, according to some embodiments of the present disclosure. FIG. 12 illustrates a diagram 1200 of a mesh with four vertices and three triangular faces and a corresponding attribute map, according to some embodiments of the present disclosure.

An example of a surface, represented by a mesh with attribute mapping characteristics (e.g., FIG. 11) that includes four vertices and three faces is depicted in FIG. 12. A position in space describes each vertex by X, Y, Z coordinates. U and V denote attribute coordinates in the 2D texture vertex map. Each face is defined by three pairs of vertex indices, texture vertex coordinates that forms a triangle in 3D space, and a triangle in the 2D texture map.

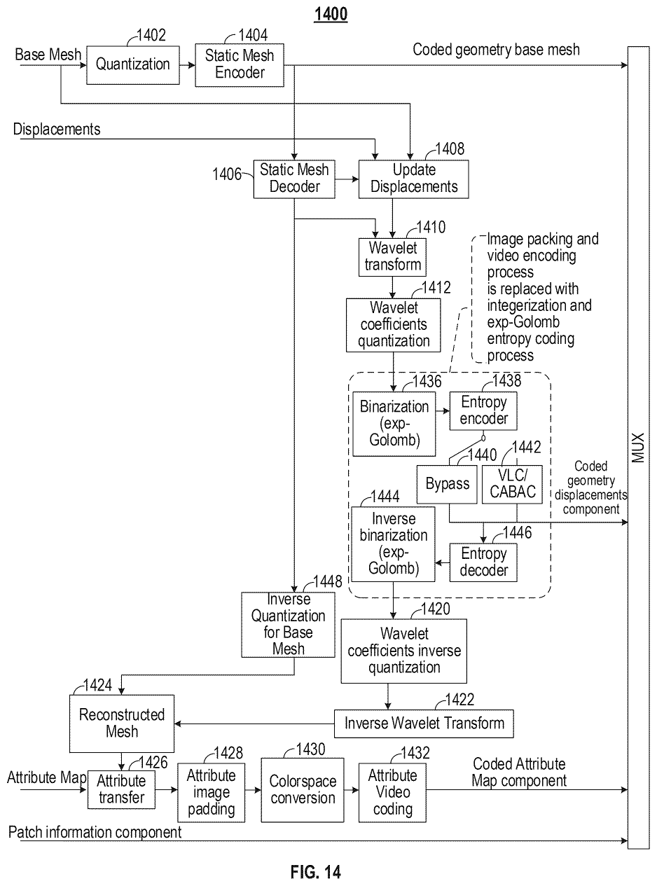

FIG. 13 illustrates a diagram of mesh-face orientation 1300 based on vertex-index order, according to some embodiments of the present disclosure. Referring to FIG. 13, the orientation of the face is determined using the right-hand coordinate system. The face includes three vertices that belong to three edges, and the three vertex indices describe each face. A manifold mesh is a mesh where one edge belongs to two different faces at most, as shown on the left-hand side of FIG. 13. On the other hand, a non-manifold mesh is a mesh with an edge that belongs to more than two faces, as shown on the right-hand side of FIG. 13.

Unfortunately, the image-packing process for wavelet-transform coefficients in the above-described technique may only start once the first wavelet coefficient is quantized. Moreover, the video encoding process can only begin once the final wavelet coefficient has been packed into a 2D image. This increases the length of the encoding procedure, while at the same time increases the computational complexity of the related operations.

To overcome these and other challenges, the present disclosure provides an exemplary mesh encoding/decoding technique in which the binarization process can be implemented immediately after quantization of the first wavelet coefficient. Here, the first exponential-Golomb (exp-Golomb) coded coefficient may be encoded after the first wavelet coefficient is binarized. Using exp-Golomb coding simplifies the encoding process by eliminating the image packing process. Correspondingly, the delay between wavelet quantization and displacement component coding is eliminated.

In some embodiments, the exemplary mesh encoding/decoding technique may encode/decode the wavelet-transform coefficients using zero-run length coding. The zero-run length coding technique described herein removes the parsing dependency and can be applied immediately after quantizing the first wavelet coefficient. The zero-run length coding may be applied to either encode a value of a symbol, or to encode a number of consecutive zero coefficients along the space scanning curve.

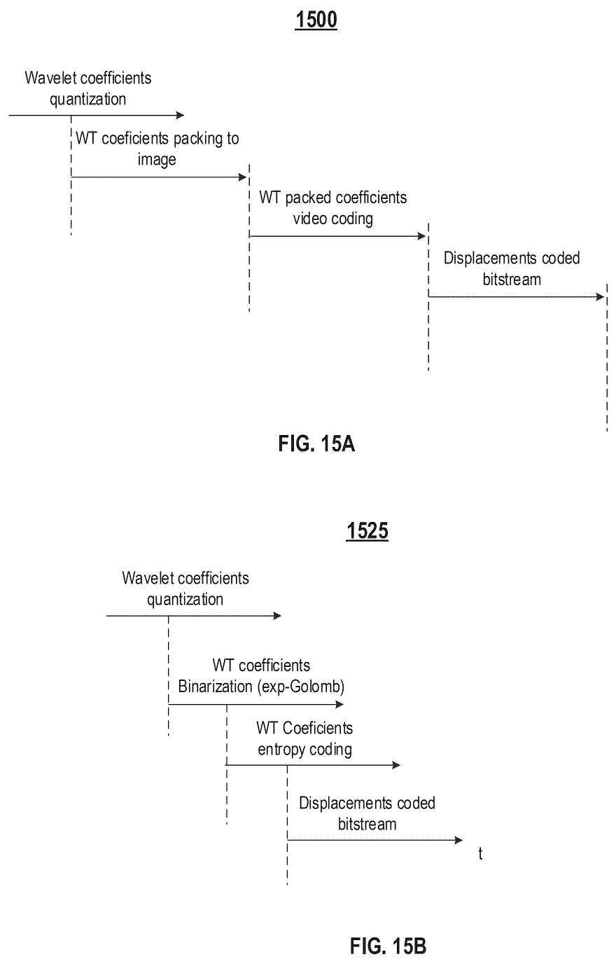

Additional details of the exemplary mesh encoding/decoding techniques are described below in connection with FIGS. 14-23.

FIG. 14 illustrates a detailed diagram of an exemplary encoder architecture 1400 for parametrized mesh-coding with exp-Golomb displacements coding, according to some embodiments of the present disclosure. As illustrated in FIG. 14, rather than using an image/video encoder, the exemplary encoder architecture of the present disclosure applies exp-Golomb binarization with further entropy coding. In this case, the quantized wavelet-transform coefficients are binarized, and each displacement component is encoded with an exp-Golomb codeword.

During pre-processing (not illustrated in FIG. 14), mesh segmentation may be applied to a mesh to create segments or blocks of mesh content representing individual objects/regions of interest/volumetric tiles, semantic blocks, etc. Then, mesh decimation may be performed to generate a base mesh. The base mesh may be coded with an undefined static mesh encoder. The base mesh may be decoded and recursively subdivided to the level defined by the encoder, as described below. In another pre-processing operation, mesh displacements may be calculated between the subdivided mesh and the original surface for each level of transform. The displacements are processed with a wavelet transform, as described below.

Referring to the operations of FIG. 14, the base mesh may be quantized by a quantization component 1402 and encoded using a static mesh encoder 1404. These operations are agnostic to the type mesh encoding scheme used to compress the base mesh. Mesh displacements may be input to an update-displacements component 1408, which updates the displacements based on information received from static mesh decoder 1406. This information may be related to the decimated base mesh, for example. Once updated, the mesh displacements may be input to a wavelet-transform component 1410. The mesh displacements may be processed by a hierarchical wavelet transform (or another transform) that recursively applies refinement layers to the reconstructed base mesh. The wavelet-transform coefficients may be quantized by wavelet-coefficient quantization component 1412.

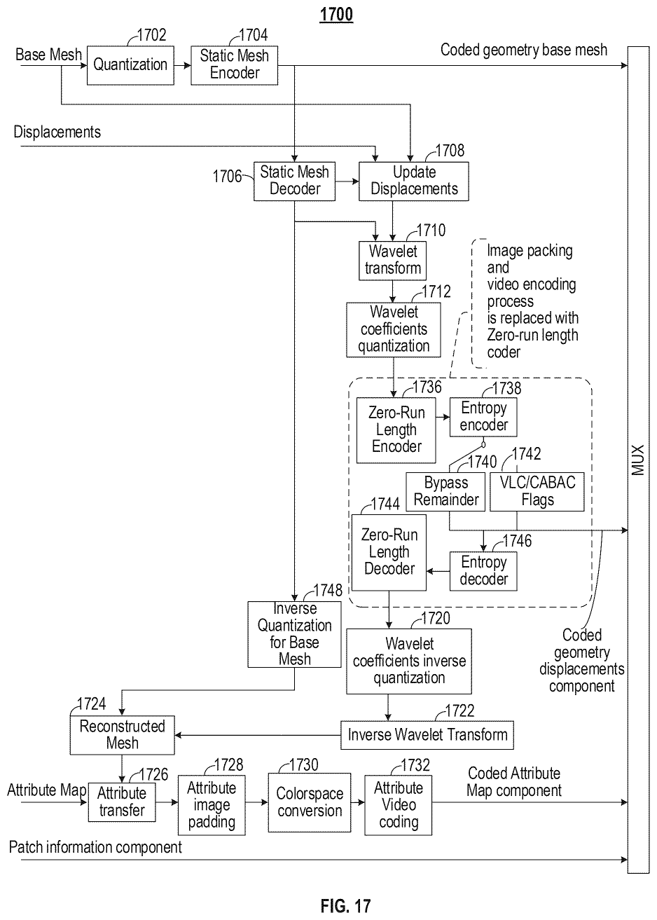

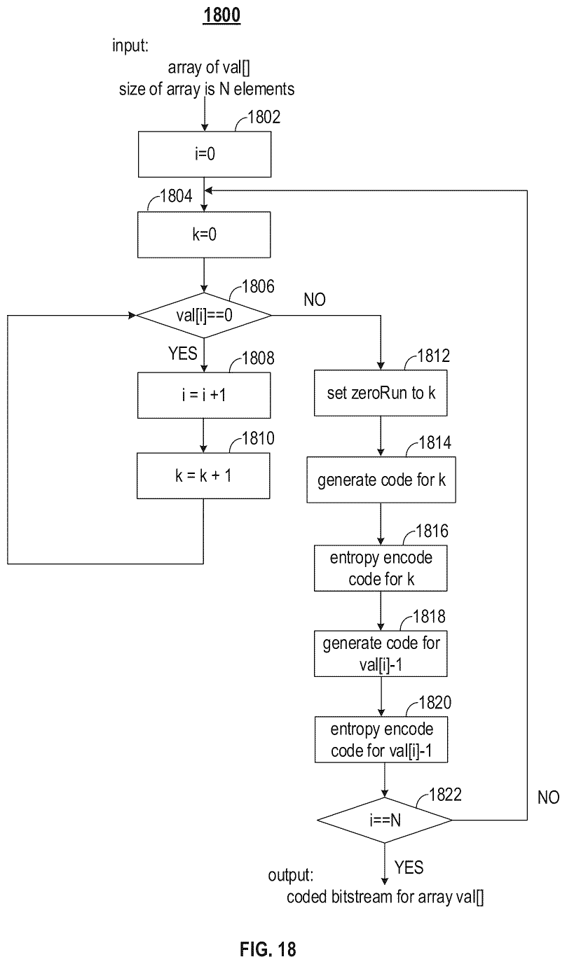

A binarization component 1436 (e.g., an exp-Golomb binarization component) may binarize the quantized wavelet-transform received from wavelet-coefficient quantization component 1412. The binarized (and quantized) wavelet-transform coefficients are input to entropy encoder 1438, which entropy encodes the binarized wavelet-transform coefficients. For instance, the quantized wavelet-transform coefficients are binarized, and each displacement component is encoded with an exp-Golomb codeword. Put another way, the wavelet-transform coefficients are converted to a fix-point representation with a precision indicated in the coded bitstream at either slice, picture, or sequence level and binarized with exp-Golomb codes, as depicted in FIG. 16A. Binarized wavelet-transform coefficients may be encoded by entropy encoder 1438 using a bypass encoder 1440 or a context-adaptive encoder 1442. Context-adaptive encoder 1442 may include a context-adaptive variable-length coder (CAVLC) or a context-adaptive binary-arithmetic coder (CABAC). One coefficient-encoding technique is bypass entropy coding, where one input-bin equals one output-bit. Additionally and/or alternatively, the context-adaptive entropy coding technique may be used for the input stream of bins. Additional details of the operations performed by binarization component 1436 and entropy encoder 1438 are provided below in connection with FIG. 16A.

The binarized-encoded wavelet-transform coefficients may be input to entropy decoder 1446. Entropy decoder 1446 may include a bypass or context adaptive decoder, which reconstructs the wavelet-transform coefficients. Inverse-binarization component 1444 may apply inverse quantization to the reconstructed wavelet-coefficient image/video generated during the image/video decoding operations, and received from entropy decoder 1446. Wavelet-coefficient inverse quantization component 1420 may perform an inverse quantization, the output of which is received by inverse wavelet-transform component 1422. Inverse wavelet-transform component 1422 may generate reconstructed mesh-displacements by applying an inverse wavelet-transform to the inverse quantized wavelet-transform coefficients (e.g., reconstructed wavelet-transform coefficients). The reconstructed wavelet-transform coefficients are input to the reconstructed mesh component 1424, along with an inverse quantization of the base mesh from inverse quantization for base mesh component 1448.

Static mesh decoder 1406 may decode the base mesh from the coded-geometry bit-stream output by static mesh encoder 1404. Once decoded, static mesh decoder 1406 may recursively subdivide the base mesh to the level defined by static mesh encoder 1404. Inverse-quantization for base mesh component 1448 may remove quantization from the base mesh. For instance, reconstructed-mesh component 1424 may apply the mesh displacements to the subdivided base mesh at each level of transform recursively to generate the reconstructed mesh consisting of blocks representing individual objects/regions of interest/volumetric tiles, semantic blocks, etc.

The de-quantized base mesh may then be input to reconstructed mesh component 1424. The reconstructed mesh may be input to an attribute transfer component 1426, along with a preconstructed attribute map. Once the attributes are transferred to the reconstructed mesh, an attribute image padding component 1428 may apply image padding to the reconstructed mesh with attribute transfer. Colorspace conversion 1430 may perform a colorspace conversion for the attribute map. Then, attribute video-coding component 1432 may encode the attribute map. The coded attribute map, patch information, and the coded-geometry base-mesh may be input to multiplexer 1434 for input to a bitstream.

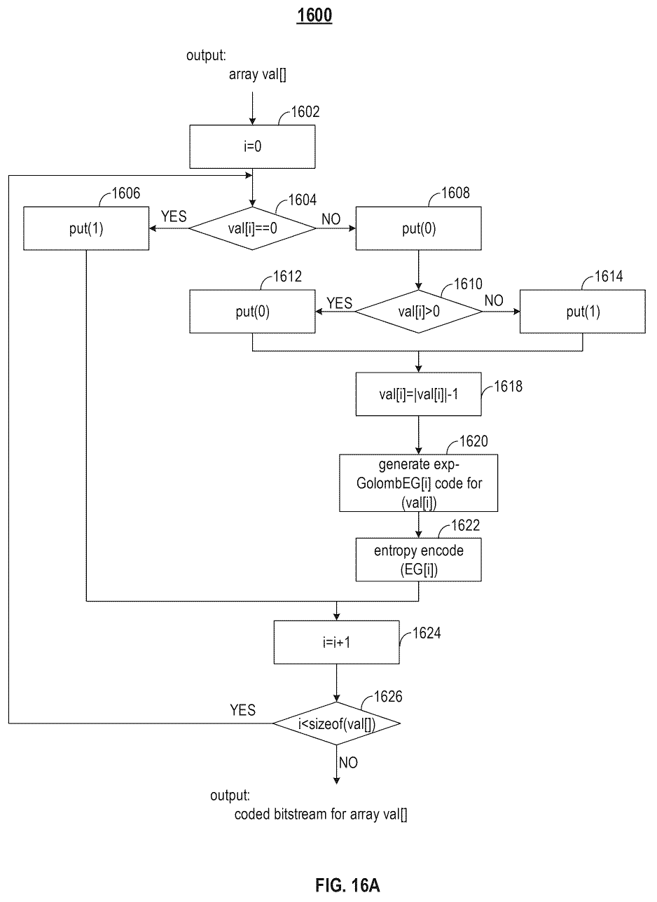

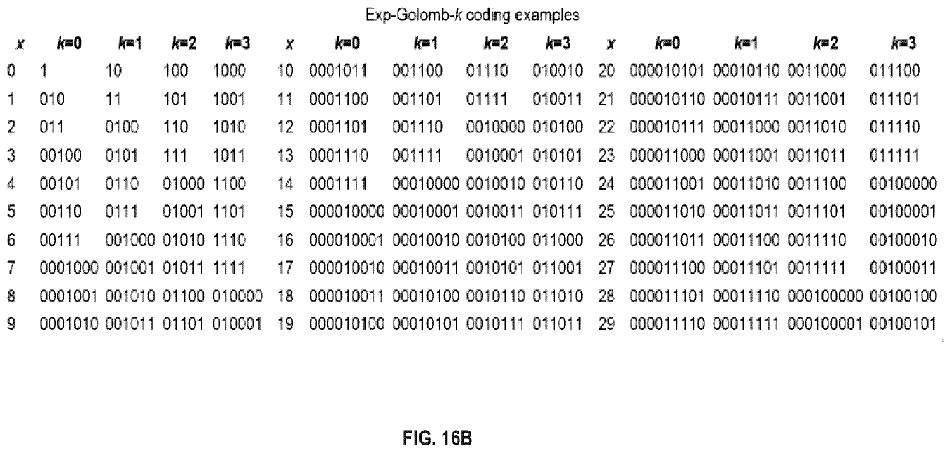

FIG. 15A illustrates a diagram of an example mesh-coding process timing diagram 1500, according to some embodiments of the present disclosure. FIG. 15B illustrates a diagram of an exemplary mesh-coding process timing diagram 1525, according to some embodiments of the present disclosure. Referring to FIG. 15A, the packing process for wavelet-transform coefficients starts once the first wavelet coefficient is quantized. The video encoding process can only begin once the final wavelet coefficient has been packed into a 2D image. In contrast, referring to FIG. 15B, the binarization process may be implemented immediately after quantizing the first wavelet coefficient, and the first exp-Golomb coded coefficient may be encoded after binarizing the first wavelet coefficient.

FIG. 16A illustrates an exemplary bitstream-composition flow diagram 1600 (referred to hereinafter as “flow diagram 1600”) for binarized wavelet-transform coefficients, according to some embodiments of the present disclosure. Flow diagram 1600 may illustrate the operations by which wavelet-transform coefficients are converted from a floating-point representation to a fix-point representation with a precision indicated in the coded bitstream at either slice, picture, or sequence level and binarized with exp-Golomb codes. The value zero illustrated in FIG. 16A is a particular case and is not binarized but signaled in a bitstream directly as a flag. The sign of the value is then signaled as a separate flag. The non-zero fix-point values are converted to the absolute value and decreased by 1 (e.g., val=val−1) before binarization with exp-Golomb coding.

As mentioned above in connection with FIG. 14, binarization component 1436 may receive a plurality of quantized wavelet-transform coefficients from wavelet-coefficient quantization component 1412. The plurality of quantized wavelet-transform coefficients may include an array of wavelet-transform coefficient values. Each of the wavelet-transform coefficient values in the array may be associated with at least one mesh displacement.

To begin, at 1602, the binarization component 1436 may initialize a local variable i to a first value (e.g., i=0). At 1604, the binarization component 1436 may determine whether the wavelet-transform coefficient value (e.g., val[i]) is equal to the first value of the local variable. If “YES” at 1604, the operations may move to 1606, where binarization component 1436 may generate a bit value of “1” otherwise, if “NO” at 1604, the operations may move to 1608, where binarization component 1436 may generate a bit value of “0”. At 1610, binarization component 1436 may determine whether the wavelet-transform coefficient is less than the first value of the local variable i. If “YES” at 1610, the operations may move to 1612, where binarization component 1436 may generate a bit value of “0”; otherwise, if “NO” at 1610, the operations may move to 1614, where binarization component 1436 may generate a bit value of “1”. At 1618, binarization component 1436 may generate an updated wavelet-transform coefficient value by calculating the absolute value of the wavelet-transform coefficient value minus 1. At 1620, binarization component 1436 may generate an exp_Golomb code (e.g., EG[i]) for the wavelet-transform coefficient value. At 1622, entropy encoder 1438 may entropy encode EG[i]. At 1624, binarization component 1436 may increment the first value of the local variable i to a second value of the local variable (e.g., i+1). At 1626, the binarization component 1436 may determine whether the second value of the local variable is less than a size of the array of wavelet-transform coefficient values. If “YES” at 1626, the operation may return to 1604; otherwise, if “NO” at 1626, entropy encoder 1438 may output a coded bitstream for the wavelet-transform coefficient value.

Still referring to FIG. 16, the floating-point values of the wavelet-transform coefficients c (i) may be converted to fixed-point representation with a defined number of bits, which is denoted as “fixedLength.” The number of bits used to convert the floating-point value to fix-point representation may be defined according to expression (2).

$$fixedLength = Ceil ( Log 2 ( c Max + 1 ) ) . \qquad ( 2 )$$

In this case, the indexing of bins for the fixedLength is such that the bin index zero (e.g., binIdx=0) relates to the most significant bit with increasing values of binIdx towards the least significant bit.

When the wavelet transform is implemented in the form of discrete wavelet transform and is implemented in a fixed-point format, no integer conversion is applied. Here, exp-Golomb binarization can be directly applied to the wavelet-transform coefficients.

In some embodiments, a special case may be applied for the entropy coding/signaling of the exp-Golomb values. For example, when the special 1-bit flag “eqZero” is introduced to indicate that the value is equal to zero. If the value of the eqZero flag is false, a flag 1-bit flag sigFlag is signaled to indicate the sign, and then the exp-Golomb values for c (i) are coded. In this case symbolVal=symbolVal−1 (e.g., val[i]=val[i]−1). The generalization of the k-th order Exp-Golomb binarization process is described below.

For instance, the bin string of the k-th order exp-Golomb binarization process for each value symbolVal c(i) is specified as follows, where each call of the function put (X), with X being equal to 0 or 1, adds the binary value X at the end of the bin string:

```
absV = Abs( symbolVal )
stopLoop = 0
do
    if( absV >= ( 1 << k) ) {
          put( 1)
          absV = absV - (1 << k)
          k++
    } else {
          put( 0 )
          while( k -- )
            put( ( absV >> k ) & 1 )
          stopLoop = 1
    }
while( !stopLoop ).
```

The order of exp-Golomb code can be fixed or signaled in the bitstream, as shown in diagram 1625 of FIG. 16B.

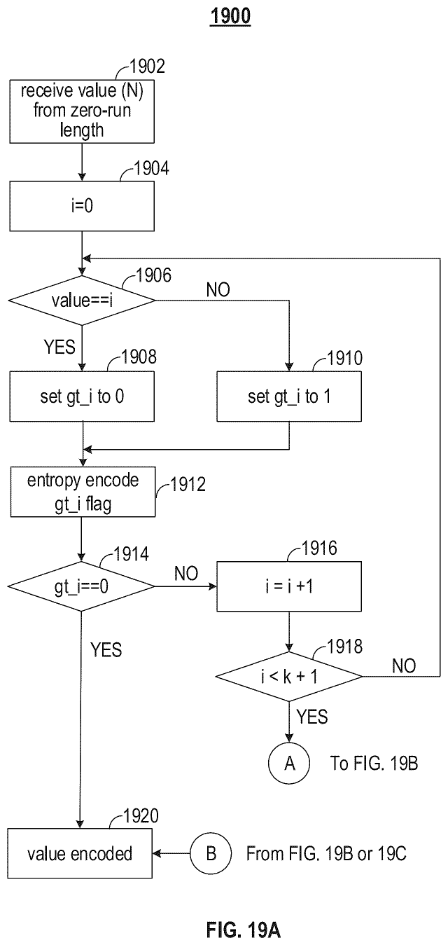

FIG. 17 illustrates a detailed diagram of an exemplary encoder architecture 1700 for parametrized mesh coding with zero-run length coding, according to some embodiments of the present disclosure. As illustrated in FIG. 17, rather than using an image/video encoder, the exemplary encoder architecture of the present disclosure applies zero-run length coding with further entropy coding.

During pre-processing (not illustrated in FIG. 17), mesh segmentation may be applied to a mesh to create segments or blocks of mesh content representing individual objects/regions of interest/volumetric tiles, semantic blocks, etc. Then, mesh decimation may be performed to generate a base mesh, and the base mesh is coded with an undefined static mesh encoder. The base mesh may be decoded and recursively subdivided to the level defined by the encoder, as described below. In another pre-processing operation, mesh displacements may be calculated between the subdivided mesh and the original surface for each level of transform. The displacements are processed with a wavelet transform, as described below.

Referring to the operations of FIG. 17, the base mesh may be quantized by a quantization component 1702 and encoded using a static mesh encoder 1704. These operations are agnostic to the type of mesh encoding scheme used to compress the base mesh. Mesh displacements may be input to an update-displacements component 1708, which updates the displacements based on information received from static mesh decoder 1706. This information may be related to the decimated base mesh, for example. Once updated, the mesh displacements may be input to a wavelet-transform component 1710. The mesh displacements may be processed by a hierarchical wavelet transform (or another transform) that recursively applies refinement layers to the reconstructed base mesh. The wavelet-transform coefficients may be quantized by wavelet-coefficient quantization component 1712.

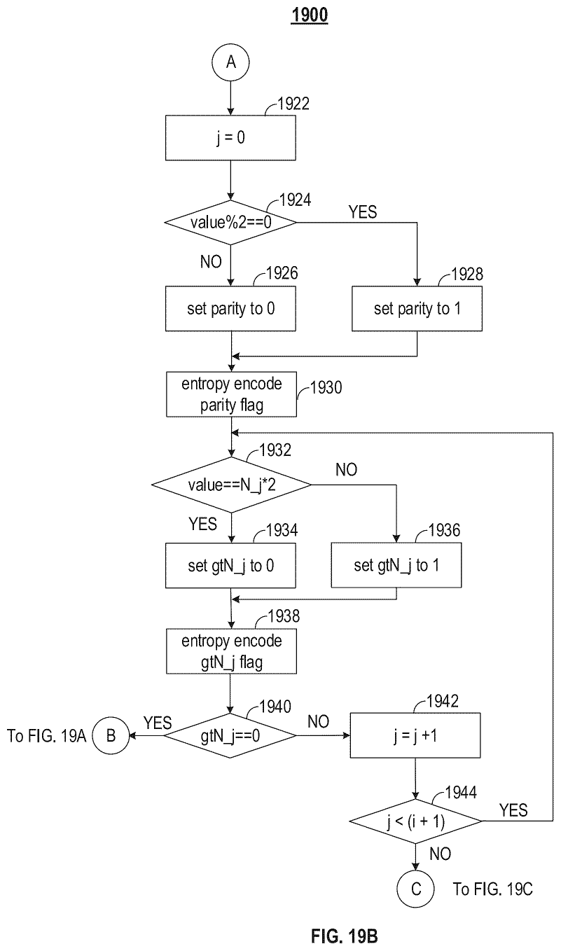

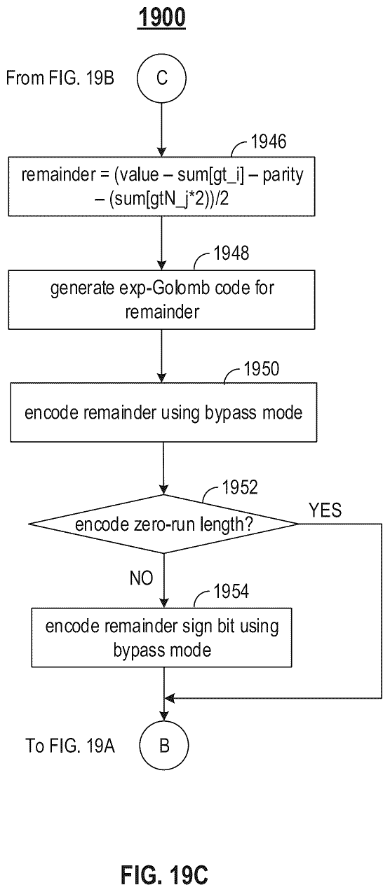

A zero-run length encoder 1736 may scan the quantized wavelet-transform coefficients along a 3D-space scanning pattern (e.g., Morton, Hilbert, or other order) before conversion to a zero-run length code. The corresponding zero-runs and non-zero coefficients may be encoded as described below in connection in FIGS. 18 and 19A-19C. The zero-run length code is input to entropy encoder 1738 for entropy encoding. The zero-run length code may be encoded by entropy encoder 1738 using a bypass encoder 1740 (e.g., remainder encoder) or a context-adaptive encoder 1742 (e.g., flags encoder). Context-adaptive encoder 1742 may include a CAVLC or a CABAC.

The entropy encoded zero-run length code may be input to entropy decoder 1746. Entropy decoder 1746 may include a bypass or context adaptive decoder, which may apply entropy decoding to the zero-run length code. Zero-run length decoder 1744 may apply inverse quantization to the reconstructed wavelet-coefficient image/video generated during the image/video decoding operations. Wavelet-coefficient inverse quantization component 1720 may perform an inverse quantization, the output of which is sent to inverse wavelet-transform component 1722. Inverse wavelet-transform component 1722 may generate reconstructed mesh displacements by applying an inverse wavelet-transform to the inverse-quantized wavelet-transform coefficients (e.g., reconstructed wavelet-transform coefficients). The reconstructed wavelet-transform coefficients are input to the reconstructed mesh component 1724, along with an inverse quantization of the base mesh from inverse quantization for base mesh component 1748.

Static mesh decoder 1706 may decode the base mesh from the coded-geometry bit-stream output by static mesh encoder 1704. Once decoded, static mesh decoder 1706 may recursively subdivide the base mesh to the level defined by static mesh encoder 1704. Inverse-quantization for base mesh component 1748 may remove quantization from the base mesh. For instance, reconstructed mesh component 1724 may apply the mesh displacements to the subdivided base mesh at each level of transform recursively to generate the reconstructed mesh consisting of blocks representing individual objects/regions of interest/volumetric tiles, semantic blocks, etc.

The de-quantized base mesh may then be input to reconstructed mesh component 1724. The reconstructed mesh may be input to an attribute transfer component 1726, along with a preconstructed attribute map. Once the attributes are transferred to the reconstructed mesh, an attribute image padding component 1728 may apply image padded to the reconstructed mesh with attribute transfer. Colorspace conversion 1730 may perform a color space conversion for the attribute map. Then, attribute video-coding component 1732 may encode the attribute map. The coded attribute map, patch information, and the coded-geometry base-mesh may be input to multiplexer 1734 for input to a bitstream.

FIG. 18 illustrates an exemplary zero-run length coding flow diagram 1800 (referred to hereinafter as “flow diagram 1800”) for quantized wavelet-transform coefficients, according to some embodiments of the present disclosure. As mentioned above in connection with FIG. 17, zero-run length encoder 1736 may receive a plurality of quantized wavelet-transform coefficients from wavelet-coefficient quantization component 1712. The plurality of quantized wavelet-transform coefficients may include an array of wavelet-transform coefficient values. The size of the array may include N elements (e.g., N number of wavelet-transform coefficient values) Each of the wavelet-transform coefficient values in the array may be associated with at least one mesh displacement.

Referring to FIG. 18, at 1802, zero-run length encoder 1736 may initialize a first value of a local variable i. At 1804, zero-run length encoder 1736 may initialize a first value of an external variable k. At 1806, zero-run length encoder 1736 may determine whether the wavelet-transform coefficient value is equal to the first value of the local variable i (e.g., val [i]==0). If “YES” at 1806, the operations may move to 1808; otherwise, if “NO” at 1806, the operations may move to 1812.

At 1808, zero-run length encoder 1736 may increment the first value of the local variable i to a second value (e.g., i+1). At 1810, zero-run length encoder 1736 may increment the first value of the external variable k to a second value (e.g., k+1). Then, the operations may return to 1806, where zero-run length encoder 1736 may determine whether the wavelet-transform coefficient value is equal to the second value of the local variable (e.g., val[i+1]==1).

At 1812, zero-run length encoder 1736 may set the zero-run value associated with the wavelet-transform coefficient value to the first value of the external variable k. At 1814, zero-run length encoder 1736 may generate the zero-run length code for the first value of the external variable k. At 1816, entropy encoder 1738 may entropy encode the zero-run length code for the first value of the external variable k. At 1818, zero-run length encoder 1736 may generate a zero-run length code for the wavelet-transform coefficient value minus −1 (e.g., val [i]−1). At 1820, entropy encoder 1738 may entropy encode the zero-run length code for the wavelet-transform coefficient value minus 1. At 1822, zero-run length encoder 1736 may determine whether the first value of the local variable i is equal to the N number of elements in the array of wavelet-transform coefficients. If “YES” at 1822, zero-run length encoder 1736 may encode the zero-run length code for the array of wavelet-transform coefficients into the bitstream; otherwise, if “NO” at 1822, the operations may return to 1804. Additional details of the operations performed by entropy encoder 1738 are provided below in connection with FIGS. 19A-19C.

FIGS. 19A-19C illustrate an exemplary zero-run length value coding flow diagram 1900, according to some embodiments of the present disclosure.

Referring to FIG. 19A, at 1902, entropy encoder 1738 may receive a zero-run length value N from the zero-run length encoder 1736. At 1904, entropy encoder 1738 may set a first value of a first local variable i (e.g., i=0). At 1906, entropy encoder 1738 may determine whether the zero-run length value is equal to the first value of the first local variable (e.g., value==i). If “YES” at 1908, the operations may move to 1908, where entropy encoder 1738 may set a first flag (e.g., gt_i) associated with the first value of the first local variable to zero; otherwise, if “NO” at 1906, the operations may move to 1910, where entropy encoder 1738 may set the first flag associated with the first value of the first local variable to one.

At 1912, context-adaptive encoder 1742 may entropy encode the first flag associated with the first value of the first local variable. At 1914, entropy encoder 1738 may determine whether the first flag associated with the first value of the first local variable is equal to the first value of the first local variable (e.g., gt_i==0). If “YES” at 1914, the operations may move to 1920, where context-adaptive encoder 1742 may determine that the zero-run length value (e.g., N) is encoded; otherwise, if “NO” at 1914, the operations may move to 1916, where entropy encoder 1738 may increment the first value of the first local variable to a second value SUBSTITUTE SPECIFICATION [CLEAN] (e.g., i+1). At 1918, entropy encoder 1738 may determine whether the second value of the first local variable is less than a first value of an external variable k plus 1 (e.g., i<k+1). If “NO” at 1928, the operations may return to 1906; otherwise, if “YES” at 1918, the operations may move to 1922 in FIG. 19B.

Referring to FIG. 19B, at 1922, zero-run length encoder 1736 may initialize a first value of a second local variable j (e.g., j=0). At 1924, zero-run length encoder 1736 may determine whether the zero-run length value divided by 2 is equal to the first value of the second local variable. If “YES” at 1924, the operations may move to 1928, where zero-run length encoder 1736 may set a parity value N_j to 1; otherwise, if “NO” at 1924, the operations may move to 1926, where zero run length encoder 1737 may set the parity value to 0. The parity value may also be referred to as an “indicator bit.” At 1930, entropy encoder 1738 may entropy encode the parity value. At 1932, zero-run length encoder 1932 may determine whether the zero-run length value is equal to the parity value multiplied by two. If “YES” at 1932, the operations may move to 1934, where zero-run length encoder 1736 may set a parity flag gtN_j (e.g., a second flag) to zero; otherwise, if “NO” at 1932, the operations may move to 1936, where zero-run length encoder 1736 may set the parity flag to 1. At 1938, context-adaptive encoder 1742 may entropy encode the parity flag. At 1940, zero-run length encoder 1736 may determine whether the parity flag is equal to the first value of the second local variable (e.g., gtN_j==0). If “YES” at 1940, the operations may return to 1920 in FIG. 19A; otherwise, if “NO” at 1940, zero-run length encoder 1736 may increment the first value of the second local variable to a second value (e.g., j+1). At 1944, zero-run length encoder 1736 may determine whether the second value of the second local variable is less than the second value of the first local variable plus 1. If “YES” at 1944, the operations may return to 1932; otherwise, if “NO” at 1944, the operations may move to 1946 in FIG. 19C.

Referring to FIG. 19C, zero-run length encoder 1736 may calculate a remainder of the zero-run length value for encoding, where the remainder=(value−sum[gt_i]−parity−(sum[gtN_j*2))/2. At 1948, zero-run length encoder 1736 may generate an exp-Golomb code for the remainder. At 1950, bypass encoder 1740 may encoder the remainder. At 1952, zero-run length encoder 1736 may determine whether the zero-run length value is encoded. If “NO” at 1952, bypass encoder 1740 may encode the remainder sign bit using a bypass mode; otherwise, if “YES” at 1952, the operations may move to 1920 in FIG. 19A. The generalization of the k-th order Exp-Golomb binarization process is described below.

In case of non-zero code the sign bit is encoded as 1, which indicates a positive number, and 0 indicates a negative number as follows in expression (3).

$$coefficient = ( 2 * sign - 1 ) * ( g t 0 + gt 1 + … + gtK + parity + ( gtN 1 + gtN 2 + … + gtN 1 + remainder ) * 2 + 1 ) , \qquad ( 3 )$$

where coefficient is non-zero wavelet coefficient, and the sign is a binary.

The bin string of the k-th order Exp-Golomb binarization process for each value symbolVal c(i) is specified as follows, where each call of the function put (X), with X being equal to 0 or 1, adds the binary value X at the end of the bin string:

```
absV = Abs( symbolVal )
stopLoop = 0
do
    if( absV >= ( 1 << k) ) {
          put( 1)
          absV = absV - (1 << k)
          k++
    } else {
          put( 0 )
          while( k -- )
            put( ( absV >> k ) & 1 )
          stopLoop = 1
    }
while( !stopLoop ).
```

Referring again to FIG. 17, for decoding, the flags and corresponding syntax elements are decoded from the bitstream by entropy decoder 1746 using context coding for flags and de binarization of bypass coded remainder.

The values of coded displacement wavelet-transform coefficients are reconstructed by entropy decoder 1746 using expression (4)

$$value = ( {\sum }_{i = 0}^{k} g {t}_{i} + parity + ( remainder + {\sum }_{j = 0}^{l} g t {N}_{j} ) * 2 ) * * ( 2 * sign - 1 ) . \qquad ( 4 )$$

The zero-run length wavelet-transform coefficients may be reconstructed by zero-run length decoder 1744 using expression (5).

$$value = {\sum }_{i = 0}^{k} gt\_i + parity + ( remainder + {\sum }_{j = 0}^{l} gtN\_j ) * 2 , \qquad ( 5 )$$

where, the values of k and i may be different for zero-run length and coefficient coding.

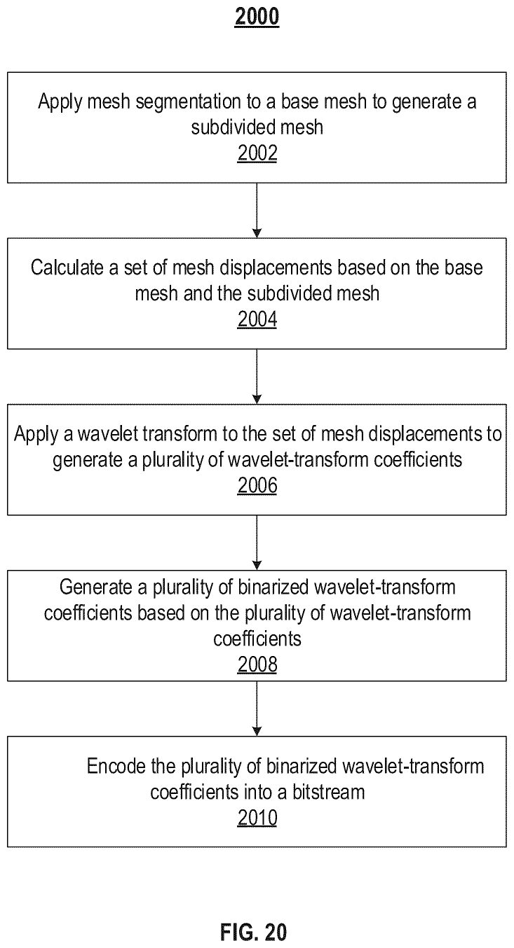

FIG. 20 illustrates a flow chart of an exemplary method 2000 of mesh encoding, according to some embodiments of the present disclosure. Method 2000 may be performed by encoder 101 of encoding system 100 or any other suitable point cloud decoding systems. Method 2000 may include operations 2002-2010 as described below. It is understood that some of the operations may be optional, and some of the operations may be performed simultaneously, or in a different order other than shown in FIG. 20.

At 2002, the encoder may apply mesh segmentation to a base mesh to generate a subdivided mesh. Mesh segmentation may be applied using any of the techniques described above in connection with FIG. 14.

At 2004, the encoder may calculate a set of mesh displacements based on the base mesh and the subdivided mesh. Mesh displacements using any of the techniques described above in connection with FIG. 14.

At 2006, the encoder may apply a wavelet transform to the set of mesh displacements to generate a plurality of wavelet-transform coefficients. The wavelet transform may be applied to the set of mesh displacements using any of the techniques described above in connection with FIG. 14.

At 2008, the encoder may generate a plurality of binarized wavelet-transform coefficients based on the plurality of wavelet-transform coefficients. The plurality of binarized wavelet-transform coefficients may be generated using any of the techniques described above in connection with FIGS. 14 and 16A.

At 2010, the encoder may encode the plurality of binarized wavelet-transform coefficients into a bitstream. The plurality of binarized wavelet-transform coefficients may be encoded using any of the techniques described above in connection with FIGS. 14 and 16A.

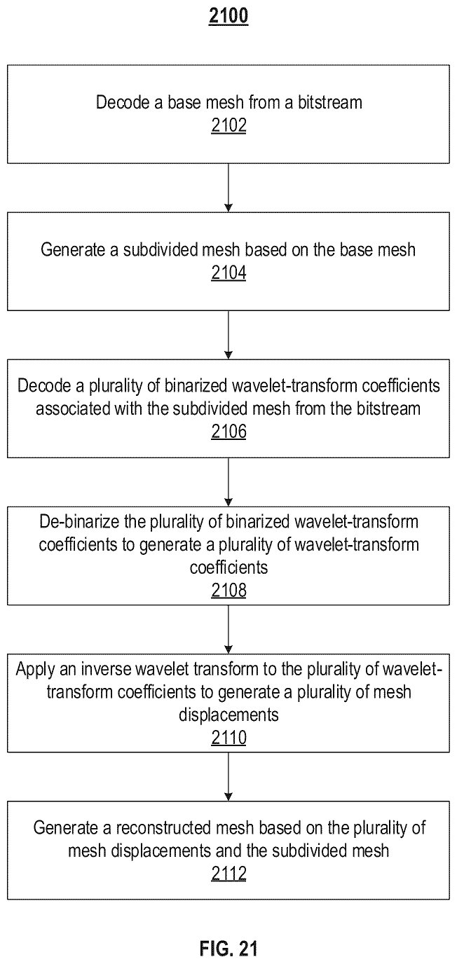

FIG. 21 illustrates a flow chart of an exemplary method 2100 of point cloud decoding, according to some embodiments of the present disclosure. Method 2100 may be performed by decoder 201 of decoding system 200 or any other suitable point cloud decoding systems. Method 2100 may include operations 2102-2112 as described below. It is understood that some of the operations may be optional, and some of the operations may be performed simultaneously, or in a different order other than shown in FIG. 21.

At 2102, the decoder may decode a base mesh from a bitstream. The base mesh may be decoded from the bitstream using any of the techniques described above in connection with FIG. 14.

At 2104, the decoder may generate a subdivided mesh based on the base mesh. The subdivided base mesh may be generated using any of the techniques described above in connection with FIG. 14.

At 2106, the decoder may decode a plurality of binarized wavelet-transform coefficients associated with the subdivided mesh from the bitstream. The plurality of binarized wavelet-transform coefficients may be decoded using any of the techniques described above in connection with FIG. 14.

At 2108, the decoder may de-binarize the plurality of binarized wavelet-transform coefficients to generate a plurality of wavelet-transform coefficients. The plurality of binarized wavelet-transform coefficients using any of the techniques described above in connection with FIG. 14.

At 2110, the decoder may apply an inverse wavelet transform to the plurality of wavelet-transform coefficients to generate a plurality of mesh displacements. The inverse wavelet transform may be applied to the plurality of wavelet-transform coefficients using any of the techniques described above in connection with FIG. 14.

At 2112, the decoder may generate a reconstructed mesh based on the plurality of mesh displacements and the subdivided mesh. The reconstructed mesh may be generated using any of the techniques described above in connection with FIG. 14.

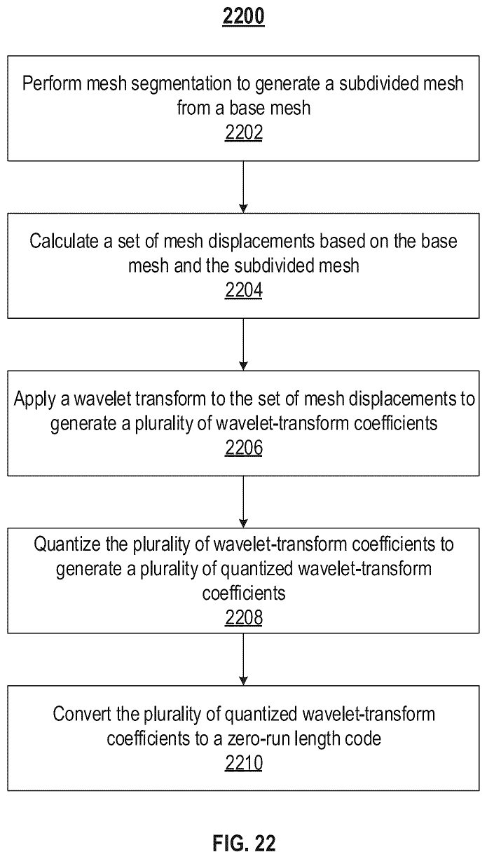

FIG. 22 illustrates a flow chart of an exemplary method 2200 of mesh encoding, according to some embodiments of the present disclosure. Method 2200 may be performed by encoder 101 of encoding system 100 or any other suitable point cloud decoding systems. Method 2200 may include operations 2202-2210 as described below. It is understood that some of the operations may be optional, and some of the operations may be performed simultaneously, or in a different order other than shown in FIG. 22.

At 2202, the encoder may perform mesh segmentation to generate a subdivided mesh from a base mesh. Mesh segmentation may be applied using any of the techniques described above in connection with FIG. 17.

At 2204, the encoder may calculate a set of mesh displacements based on the base mesh and the subdivided mesh. The wavelet transform may be applied to the set of mesh displacements using any of the techniques described above in connection with FIG. 17.

At 2206, the encoder may apply a wavelet transform to the set of mesh displacements to generate a plurality of wavelet-transform coefficients. The wavelet transform may be applied to the set of mesh displacements using any of the techniques described above in connection with FIG. 17.

At 2208, the encoder may quantize the plurality of wavelet-transform coefficients to generate a plurality of quantized wavelet-transform coefficients. The plurality of wavelet-transform coefficients using any of the techniques described above in connection with FIG. 17.

At 2210, the encoder may convert the plurality of quantized wavelet-transform coefficients to a zero-run length code. The plurality of quantized wavelet-transform coefficients may be converted to a zero-run length code using any of the techniques described above in connection with FIGS. 17, 18, and 19A-19C.

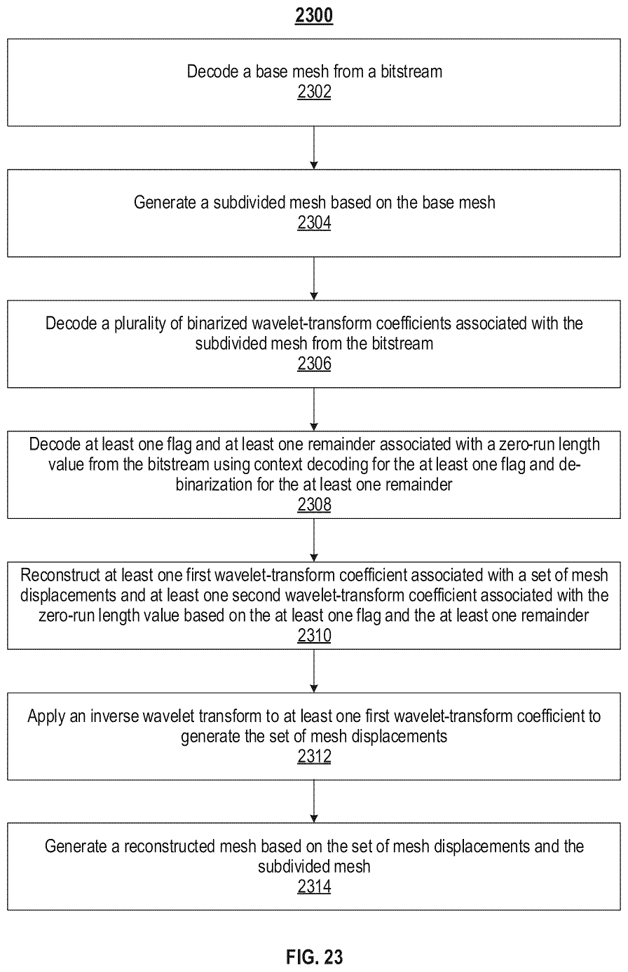

FIG. 23 illustrates a flow chart of an exemplary method 2300 of point cloud decoding, according to some embodiments of the present disclosure. Method 2300 may be performed by decoder 201 of decoding system 200 or any other suitable point cloud decoding systems. Method 2300 may include operations 2302-2314 as described below. It is understood that some of the operations may be optional, and some of the operations may be performed simultaneously, or in a different order other than shown in FIG. 23.

At 2302, the decoder may decode a base mesh from a bitstream. The base mesh may be decoded from the bitstream using any of the techniques described above in connection with FIG. 17.

At 2304, the decoder may generate a subdivided mesh based on the base mesh. The subdivided mesh may be generated using any of the techniques described above in connection with FIG. 17.

At 2306, the decoder may decode a plurality of binarized wavelet-transform coefficients associated with the subdivided mesh from the bitstream. The plurality of binarized wavelet-transform coefficients may be decoded using any of the techniques described above in connection with FIG. 17.

At 2308, the decoder may decode at least one flag and at least one remainder associated with a zero-run length value from the bitstream using context decoding for the at least one flag and de-binarization for the at least one remainder. The at least one flag and at least one remainder associated with a zero-run length value may be decoded using any of the techniques described above in connection with FIG. 17.

At 2310, the decoder may reconstruct at least one first wavelet-transform coefficient associated with a set of mesh displacements and at least one second wavelet-transform coefficient associated with the zero-run length value based on the at least one flag and the at least one remainder. The at least one first wavelet-transform coefficient associated with a set of mesh displacements and at least one second wavelet-transform coefficient associated with the zero-run length value based on the at least one flag and the at least one remainder may be reconstructed using any of the techniques described above in connection with FIG. 17.

At 2312, the decoder may apply an inverse wavelet transform to at least one first wavelet-transform coefficient to generate the set of mesh displacements. The inverse wavelet transform may be applied to at least one first wavelet-transform coefficient using any of the techniques described above in connection with FIG. 17.

At 2314, the decoder may generate a reconstructed mesh based on the set of mesh displacements and the subdivided mesh. The reconstructed mesh may be generated using any of the techniques described above in connection with FIG. 17.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method for encoding a mesh is provided. The method may include applying, by at least one processor, mesh segmentation to a base mesh to generate a subdivided mesh. The method may include calculating, by the at least one processor, a set of mesh displacements based on the base mesh and the subdivided mesh. The method may include applying, by the at least one processor, a wavelet transform to the set of mesh displacements to generate a plurality of wavelet-transform coefficients. The method may include generating, by the at least one processor, a plurality of binarized wavelet-transform coefficients based on the plurality of wavelet-transform coefficients. The method may include encoding, by the at least one processor, the plurality of binarized wavelet-transform coefficients into a bitstream.

In some embodiments, the method may include decimating, by the at least one processor, the set of points to generate the base mesh.

In some embodiments, the subdivided mesh may include a plurality of mesh segments. In some embodiments, each of the plurality of mesh segments may represent at least one region of interest in the base mesh.

In some embodiments, the method may include generating, by the at least one processor, a quantized base mesh. In some embodiments, the method may include encoding, by the at least one processor, the quantized base mesh to the bitstream using a static-mesh encoder.

In some embodiments, the generating, by the at least one processor, the plurality of binarized wavelet-transform coefficients based on the plurality of wavelet-transform coefficients may include generating a fixed-point representation of the plurality of wavelet-transform coefficients. In some embodiments, the generating, by the at least one processor, the plurality of binarized wavelet-transform coefficients based on the plurality of wavelet-transform coefficients may include applying an exponential-Golomb code to the fixed-point representation of the plurality of wavelet-transform coefficients to generate the plurality of binarized wavelet-transform coefficients.

In some embodiments, the plurality of wavelet-transform coefficients may be binarized at a slice-level, a picture-level, or a sequence-level.

In some embodiments, the plurality of binarized wavelet-transform coefficients may be encoded into the bitstream using an entropy encoder. In some embodiments, the entropy encoder may include one or more of a bypass encoder or a context-adaptive encoder.

According to another aspect of the present disclosure, an encoder for encoding a mesh is provided. The system may include at least one processor and memory storing instructions. The memory storing instructions, which when executed by the at least one processor, may cause the at least one processor to apply mesh segmentation to a base mesh to generate a subdivided mesh. The memory storing instructions, which when executed by the at least one processor, may cause the at least one processor to calculate a set of mesh displacements based on the base mesh and the subdivided mesh. The memory storing instructions, which when executed by the at least one processor, may cause the at least one processor to apply a wavelet transform to the set of mesh displacements to generate a plurality of wavelet-transform coefficients. The memory storing instructions, which when executed by the at least one processor, may cause the at least one processor to generate a plurality of binarized wavelet-transform coefficients based on the plurality of wavelet-transform coefficients. The memory storing instructions, which when executed by the at least one processor, may cause the at least one processor to encode the plurality of binarized wavelet-transform coefficients into a bitstream.

According to a further aspect of the present disclosure, method for decoding a mesh is provided. The method may include decoding, by at least one processor, a base mesh from a bitstream. The method may include generating, by the at least one processor, a subdivided mesh based on the base mesh. The method may include decoding, by at least one processor, a plurality of binarized wavelet-transform coefficients associated with the subdivided mesh from the bitstream. The method may include de-binarizing, by the at least one processor, the plurality of binarized wavelet-transform coefficients to generate a plurality of wavelet-transform coefficients. The method may include applying, by the at least one processor, an inverse wavelet transform to the plurality of wavelet-transform coefficients to generate a plurality of mesh displacements. The method may include generating, by the at least one processor, a reconstructed mesh based on the plurality of mesh displacements and the subdivided mesh.

In some embodiments, the subdivided mesh may include a plurality of mesh segments. In some embodiments, each of the plurality of mesh segments may represent at least one region of interest in the base mesh.

In some embodiments, the de-binarizing, by the at least one processor, the plurality of binarized wavelet-transform coefficients to generate a plurality of wavelet-transform coefficients may include converting a fixed-point representation of the plurality of wavelet-transform coefficients to a plurality of floating-point values. In some embodiments, the de-binarizing, by the at least one processor, the plurality of binarized wavelet-transform coefficients to generate a plurality of wavelet-transform coefficients may include applying an exponential-Golomb code to the plurality of floating-point values of the plurality of wavelet-transform coefficients to de-binarize the plurality of binarized wavelet-transform coefficients.

In some embodiments the plurality of binarized wavelet-transform coefficients may be de-binarized at a slice-level, a picture-level, or a sequence-level.

In some embodiments, the plurality of binarized wavelet-transform coefficients may be decoded from the bitstream using an entropy decoder.

According to yet a further aspect of the present disclosure, a decoder for decoding a mesh is provided. The system may include at least one processor and memory storing instructions. The memory storing instructions, which when executed by the at least one processor, may cause the at least one processor to decode a base mesh from a bitstream. The memory storing instructions, which when executed by the at least one processor, may cause the at least one processor to generate a subdivided mesh based on the base mesh. The memory storing instructions, which when executed by the at least one processor, may cause the at least one processor to decode a plurality of binarized wavelet-transform coefficients associated with the subdivided mesh from the bitstream. The memory storing instructions, which when executed by the at least one processor, may cause the at least one processor to de-binarize the plurality of binarized wavelet-transform coefficients to generate a plurality of wavelet-transform coefficients. The memory storing instructions, which when executed by the at least one processor, may cause the at least one processor to apply an inverse wavelet transform to the plurality of wavelet-transform coefficients to generate a plurality of mesh displacements. The memory storing instructions, which when executed by the at least one processor, may cause the at least one processor to generate a reconstructed mesh based on the plurality of mesh displacements and the subdivided mesh.

According to yet a further aspect of the present disclosure, a method for encoding a mesh is provided. The method may include performing, by at least one processor, mesh segmentation to generate a subdivided mesh from a base mesh. The method may include calculating, by the at least one processor, a set of mesh displacements based on the base mesh and the subdivided mesh. The method may include applying, by the at least one processor, a wavelet transform to the set of mesh displacements to generate a plurality of wavelet-transform coefficients. The method may include quantizing, by the at least one processor, the plurality of wavelet-transform coefficients to generate a plurality of quantized wavelet-transform coefficients. The method may include converting, by the at least one processor, the plurality of quantized wavelet-transform coefficients to a zero-run length code.

In some embodiments, the zero-run length code may include one or more of at least one zero-run coefficient or at least one non-zero coefficient.

In some embodiments, the method may include encoding, by the at least one processor, the zero-run length code into a bitstream.

In some embodiments, the zero-run length code may be encoded into the bitstream using an entropy encoder. In some embodiments, the entropy encoder may include one or more of a bypass encoder or a context-adaptive encoder.

In some embodiments, the zero-run length code may include a zero-coefficient associated with a first number of consecutive zeros values and a non-zero-coefficient associated with a second number of non-zero values. In some embodiments, the encoding, by the at least one processor, the zero-run length code into the bitstream may include encoding the first number of consecutive zero values associated with the zero-coefficient using a first encoding technique. In some embodiments, the encoding, by the at least one processor, the zero-run length code into the bitstream may include encoding the second number of non-zero values associated with the non-zero-coefficient using a second encoding technique.

In some embodiments, the encoding, by the at least one processor, the zero-run length code into the bitstream may include initializing a first local variable to a first value. In some embodiments, the encoding, by the at least one processor, the zero-run length code into the bitstream may include comparing a zero-run length value to the first value of the first local variable. In some embodiments, in response to the zero-run length value being equal to the first value of the first local variable, the encoding, by the at least one processor, the zero-run length code into the bitstream may include setting a first flag associated with the first value of the first local variable to zero. In some embodiments, in response to the zero-run length value not being equal to the first value of the first local variable, the encoding, by the at least one processor, the zero-run length code into the bitstream may include setting the first flag associated with the first value of the first local variable to one. In some embodiments, the encoding, by the at least one processor, the zero-run length code into the bitstream may include encoding the first flag using an entropy encoder. In some embodiments, in response to the first flag associated with the first value of the first local variable being set to the first value of the first local variable, the encoding, by the at least one processor, the zero-run length code into the bitstream may include determining the zero-run length value is encoded. In some embodiments, in response to the first flag associated with the first value of the first local variable not being set to the first value of the first local variable, the encoding, by the at least one processor, the zero-run length code into the bitstream may include incrementing the first value of the first local variable to a second value.

In some embodiments, the encoding, by the at least one processor, the zero-run length code into the bitstream may include, in response to the second value of the first local variable not being less than an external variable value plus one, comparing the zero-run length value to the second value of the first local variable. In some embodiments, in response to the zero-run length value being equal to the second value of the first local variable, the encoding, by the at least one processor, the zero-run length code into the bitstream may include setting the first flag associated with the second value of the first local variable to zero. In some embodiments, in response to the zero-run length value not being equal to the second value of the first local variable, the encoding, by the at least one processor, the zero-run length code into the bitstream may include setting the first flag associated with the second value of the first local variable to one. In some embodiments, the encoding, by the at least one processor, the zero-run length code into the bitstream may include encoding the first flag using an entropy encode. In some embodiments, in response to the first flag associated with the second value of the first local variable being set to the second value of the first local variable, the encoding, by the at least one processor, the zero-run length code into the bitstream may include determining the zero-run length value is encoded. In some embodiments, in response to the first flag associated with the second value of the first local variable not being set to the second value of the first local variable, the encoding, by the at least one processor, the zero-run length code into the bitstream may include incrementing the second value of the first local variable to a third value.

In some embodiments, in response to the second value of the first local variable being less than an external variable value plus one, the encoding, by the at least one processor, the zero-run length code into the bitstream may include initializing a second local variable to a first value. In some embodiments, the encoding, by the at least one processor, the zero-run length code into the bitstream may include comparing the zero-run length value to the first value of the second local variable. In some embodiments, in response to the zero-run length value divided by two being equal to the first value of the second local variable, the encoding, by the at least one processor, the zero-run length code into the bitstream may include setting an indicator bit associated the second local variable to one. In some embodiments, in response to the zero-run length value divided by two not being equal to the first value of the second local variable, the encoding, by the at least one processor, the zero-run length code into the bitstream may include setting the indicator bit associated the second local variable to zero. In some embodiments, the encoding, by the at least one processor, the zero-run length code into the bitstream may include entropy encoding the indicator bit associated with the second local variable using the entropy encoder.

In some embodiments, the encoding, by the at least one processor, the zero-run length code into the bitstream may include comparing the zero-run length value to the indicator bit associated with the second local variable multiplied by two. In some embodiments, in response to the indicator bit being equal to the first value of the second local variable multiplied by two, the encoding, by the at least one processor, the zero-run length code into the bitstream may include setting a second flag associated with the indicator bit to zero. In some embodiments, in response to the indicator bit not being equal to the first value of the second local variable, the encoding, by the at least one processor, the zero-run length code into the bitstream may include setting the second flag associated with the indicator bit to one. In some embodiments, the encoding, by the at least one processor, the zero-run length code into the bitstream may include entropy encoding the second flag associated with the indicator bit using an entropy encoder.

In some embodiments, the encoding, by the at least one processor, the zero-run length code into the bitstream may include comparing the second flag associated with the indicator bit to the first value of the second local variable. In some embodiments, in response to the second flag associated with the indicator bit not being equal to the first value of the second local variable, the encoding, by the at least one processor, the zero-run length code into the bitstream may include determining the zero-run length value is encoded. In some embodiments, in response to the second flag associated with the indicator bit being equal to the first value of the second local variable, the encoding, by the at least one processor, the zero-run length code into the bitstream may include incrementing the first value of the second local variable to a second value. In some embodiments, the encoding, by the at least one processor, the zero-run length code into the bitstream may include comparing the second value of the second local variable to the first value of the first local variable plus one.

In some embodiments, in response to the second value of the second local variable being less than the first value of the first local variable plus one, the encoding, by the at least one processor, the zero-run length code into the bitstream may include determining whether the zero-run length value is less than the indicator bit multiplied by two.

In some embodiments, in response to the second value of the second local variable not being less than the first value of the first local variable plus one, the encoding, by the at least one processor, the zero-run length code into the bitstream may include determining a remainder of the zero-run length value to encode based on a summation of first local variable values minus the indicator bit minus a summation of second local variable values divided by two. In some embodiments, the encoding, by the at least one processor, the zero-run length code into the bitstream may include generating an exponential-Golomb code for the remainder of the zero-run length value. In some embodiments, the encoding, by the at least one processor, the zero-run length code into the bitstream may include encoding the remainder of the zero-run length code using a bypass encoder. In some embodiments, in response to determining that an entirety of the zero-run length value is not encoded, the encoding, by the at least one processor, the zero-run length code into the bitstream may include encoding a remainder sign of the remainder of the zero-run length value into the bitstream.

According to yet another aspect of the present disclosure, a system for encoding a mesh is provided. The system may include at least one processor and memory storing instructions. The memory storing instructions, which when executed by the at least one processor, may cause the at least one processor to perform mesh segmentation to generate a subdivided mesh from a base mesh. The memory storing instructions, which when executed by the at least one processor, may cause the at least one processor to calculate a set of mesh displacements based on the base mesh and the subdivided mesh. The memory storing instructions, which when executed by the at least one processor, may cause the at least one processor to apply a wavelet transform to the set of mesh displacements to generate a plurality of wavelet-transform coefficients. The memory storing instructions, which when executed by the at least one processor, may cause the at least one processor to quantize the plurality of wavelet-transform coefficients to generate a plurality of quantized wavelet-transform coefficients. The memory storing instructions, which when executed by the at least one processor, may cause the at least one processor to convert the plurality of quantized wavelet-transform coefficients to a zero-run length code.

According to still a further aspect of the present disclosure, a method for decoding a mesh is provided. The method may include decoding, by at least one processor, a base mesh from a bitstream. The method may include generating, by the at least one processor, a subdivided mesh based on the base mesh. The method may include decoding, by at least one processor, a plurality of binarized wavelet-transform coefficients associated with the subdivided mesh from the bitstream. The method may include decoding, by the at least one processor, at least one flag and at least one remainder associated with a zero-run length value from the bitstream using context decoding for the at least one flag and de-binarization for the at least one remainder. The method may include reconstructing, by the at least one processor, at least one first wavelet-transform coefficient associated with a set of mesh displacements and at least one second wavelet-transform coefficient associated with the zero-run length value based on the at least one flag and the at least one remainder. The method may include applying, by the at least one processor, an inverse wavelet transform to at least one first wavelet-transform coefficient to generate the set of mesh displacements. The method may include generating, by the at least one processor, a reconstructed mesh based on the set of mesh displacements and the subdivided mesh.

According to still another aspect of the present disclosure, a system for decoding a mesh is provided. The system may include at least one processor and memory storing instructions. The memory storing instructions, which when executed by the at least one processor, may cause the at least one processor to decode a base mesh from a bitstream. The memory storing instructions, which when executed by the at least one processor, may cause the at least one processor to generate a subdivided mesh based on the base mesh. The memory storing instructions, which when executed by the at least one processor, may cause the at least one processor to decode a plurality of binarized wavelet-transform coefficients associated with the subdivided mesh from the bitstream. The memory storing instructions, which when executed by the at least one processor, may cause the at least one processor to decode at least one flag and at least one remainder associated with a zero-run length value from the bitstream using context decoding for the at least one flag and de-binarization for the at least one remainder. The memory storing instructions, which when executed by the at least one processor, may cause the at least one processor to reconstruct at least one first wavelet-transform coefficient associated with a set of mesh displacements and at least one second wavelet-transform coefficient associated with the zero-run length value based on the at least one flag and the at least one remainder. The memory storing instructions, which when executed by the at least one processor, may cause the at least one processor to apply an inverse wavelet transform to at least one first wavelet-transform coefficient to generate the set of mesh displacements. The memory storing instructions, which when executed by the at least one processor, may cause the at least one processor to generate a reconstructed mesh based on the set of mesh displacements and the subdivided mesh.

In a first clause, a method for encoding a mesh is provided in the present disclosure, and the method includes:
performing, by at least one processor, mesh segmentation to generate a subdivided mesh from a base mesh;
calculating, by the at least one processor, a set of mesh displacements based on the base mesh and the subdivided mesh;
applying, by the at least one processor, a wavelet transform to the set of mesh displacements to generate a plurality of wavelet-transform coefficients;
quantizing, by the at least one processor, the plurality of wavelet-transform coefficients to generate a plurality of quantized wavelet-transform coefficients; and
converting, by the at least one processor, the plurality of quantized wavelet-transform coefficients to a zero-run length code.

In a second clause, according to the first clause, the zero-run length code includes one or more of at least one zero-run coefficient or at least one non-zero coefficient.

In a third clause, according to the first clause, the method further includes:
encoding, by the at least one processor, the zero-run length code into a bitstream.

18. In a fourth clause, according to the third clause, the zero-run length code is encoded into the bitstream using an entropy encoder, and the entropy encoder includes one or more of a bypass encoder or a context-adaptive encoder.

In a fifth clause, according to the third clause, the zero-run length code includes a zero-coefficient associated with a first number of consecutive zeros values and a non-zero-coefficient associated with a second number of non-zero values, and
the encoding, by the at least one processor, the zero-run length code into the bitstream includes:
   encoding the first number of consecutive zero values associated with the zero-coefficient using a first encoding technique; and
   encoding the second number of non-zero values associated with the non-zero-coefficient using a second encoding technique.

In a sixth clause, according to the third clause, the encoding, by the at least one processor, the zero-run length code into the bitstream includes:
initializing a first local variable to a first value;
comparing a zero-run length value to the first value of the first local variable;
in response to the zero-run length value being equal to the first value of the first local variable, setting a first flag associated with the first value of the first local variable to zero;
in response to the zero-run length value not being equal to the first value of the first local variable, setting the first flag associated with the first value of the first local variable to one;
encoding the first flag using an entropy encoder;
in response to the first flag associated with the first value of the first local variable being set to the first value of the first local variable, determining the zero-run length value is encoded; and
in response to the first flag associated with the first value of the first local variable not being set to the first value of the first local variable, incrementing the first value of the first local variable to a second value.

In a seventh clause, according to the sixth clause, the encoding, by the at least one processor, the zero-run length code into the bitstream includes:
in response to the second value of the first local variable not being less than an external variable value plus one, comparing the zero-run length value to the second value of the first local variable;
in response to the zero-run length value being equal to the second value of the first local variable, setting the first flag associated with the second value of the first local variable to zero;
in response to the zero-run length value not being equal to the second value of the first local variable, setting the first flag associated with the second value of the first local variable to one;
encoding the first flag using an entropy encoder;
in response to the first flag associated with the second value of the first local variable being set to the second value of the first local variable, determining the zero-run length value is encoded; and
in response to the first flag associated with the second value of the first local variable not being set to the second value of the first local variable, incrementing the second value of the first local variable to a third value.

In an eighth clause, according to the sixth clause, the encoding, by the at least one processor, the zero-run length code into the bitstream includes:
in response to the second value of the first local variable being less than an external variable value plus one, initializing a second local variable to a first value;
comparing the zero-run length value to the first value of the second local variable;
in response to the zero-run length value divided by two being equal to the first value of the second local variable, setting an indicator bit associated the second local variable to one;
in response to the zero-run length value divided by two not being equal to the first value of the second local variable, setting the indicator bit associated the second local variable to zero; and
entropy encoding the indicator bit associated with the second local variable using the entropy encoder.

In a ninth clause, according to the eighth clause, the encoding, by the at least one processor, the zero-run length code into the bitstream includes:
comparing the zero-run length value to the indicator bit associated with the second local variable multiplied by two;
in response to the indicator bit being equal to the first value of the second local variable multiplied by two, setting a second flag associated with the indicator bit to zero;
in response to the indicator bit not being equal to the first value of the second local variable, setting the second flag associated with the indicator bit to one; and
entropy encoding the second flag associated with the indicator bit using an entropy encoder.

In a tenth clause, according to the ninth clause, the encoding, by the at least one processor, the zero-run length code into the bitstream includes:
comparing the second flag associated with the indicator bit to the first value of the second local variable;
in response to the second flag associated with the indicator bit not being equal to the first value of the second local variable, determining the zero-run length value is encoded;
in response to the second flag associated with the indicator bit being equal to the first value of the second local variable, incrementing the first value of the second local variable to a second value; and comparing the second value of the second local variable to the first value of the first local variable plus one.

In an eleventh clause, according to the tenth clause, the encoding, by the at least one processor, the zero-run length code into the bitstream includes:
in response to the second value of the second local variable being less than the first value of the first local variable plus one, determining whether the zero-run length value is less than the indicator bit multiplied by two.

In a twelfth clause, according to the tenth clause, the encoding, by the at least one processor, the zero-run length code into the bitstream includes:
in response to the second value of the second local variable not being less than the first value of the first local variable plus one, determining a remainder of the zero-run length value to encode based on a summation of first local variable values minus the indicator bit minus a summation of second local variable values divided by two;
generating an exponential-Golomb code for the remainder of the zero-run length value;
encoding the remainder of the zero-run length code using a bypass encoder; and
in response to determining that an entirety of the zero-run length value is not encoded, encoding a remainder sign of the remainder of the zero-run length value into the bitstream.

In a thirteenth clause, an encoder for encoding a mesh is provided in the present disclosure, and the encoder includes:
at least one processor; and
memory storing instructions, which when executed by the at least one processor, cause the at least one processor to:
   perform mesh segmentation to generate a subdivided mesh from a base mesh;
   calculate a set of mesh displacements based on the base mesh and the subdivided mesh;
   apply a wavelet transform to the set of mesh displacements to generate a plurality of wavelet-transform coefficients;
   quantize the plurality of wavelet-transform coefficients to generate a plurality of quantized wavelet-transform coefficients; and
   convert the plurality of quantized wavelet-transform coefficients to a zero-run length code.

In a fourteenth clause, a method for decoding a mesh is provided in the present disclosure, and the method includes:
decoding, by at least one processor, a base mesh from a bitstream;
generating, by the at least one processor, a subdivided mesh based on the base mesh;
decoding, by at least one processor, a plurality of binarized wavelet-transform coefficients associated with the subdivided mesh from the bitstream;
decoding, by the at least one processor, at least one flag and at least one remainder associated with a zero-run length value from the bitstream using context decoding for the at least one flag and de-binarization for the at least one remainder;
reconstructing, by the at least one processor, at least one first wavelet-transform coefficient associated with a set of mesh displacements and at least one second wavelet-transform coefficient associated with the zero-run length value based on the at least one flag and the at least one remainder;
applying, by the at least one processor, an inverse wavelet transform to at least one first wavelet-transform coefficient to generate the set of mesh displacements; and
generating, by the at least one processor, a reconstructed mesh based on the set of mesh displacements and the subdivided mesh.

In a fifteenth clause, a decoder for decoding a mesh is provided, and the method includes:
at least one processor; and
memory storing instructions, which when executed by the at least one processor, cause the at least one processor to:
   decode a base mesh from a bitstream;
      generate a subdivided mesh based on the base mesh;
      decode a plurality of binarized wavelet-transform coefficients associated with the subdivided mesh from the bitstream;
      decode at least one flag and at least one remainder associated with a zero-run length value from the bitstream using context decoding for the at least one flag and de-binarization for the at least one remainder;
      reconstruct at least one first wavelet-transform coefficient associated with a set of mesh displacements and at least one second wavelet-transform coefficient associated with the zero-run length value based on the at least one flag and the at least one remainder;
      apply an inverse wavelet transform to at least one first wavelet-transform coefficient to generate the set of mesh displacements; and
      generate a reconstructed mesh based on the set of mesh displacements and the subdivided mesh.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method for encoding a mesh, comprising:
applying, by at least one processor, mesh segmentation to a base mesh to generate a subdivided mesh;
calculating, by the at least one processor, a set of mesh displacements based on the base mesh and the subdivided mesh;
applying, by the at least one processor, a wavelet transform to the set of mesh displacements to generate a plurality of wavelet-transform coefficients;
generating, by the at least one processor, a plurality of binarized wavelet-transform coefficients based on the plurality of wavelet-transform coefficients; and
encoding, by the at least one processor, the plurality of binarized wavelet-transform coefficients into a bitstream.

2. The method of claim 1, further comprising:
decimating, by the at least one processor, the set of points to generate the base mesh.

3. The method of claim 1, wherein:
the subdivided mesh includes a plurality of mesh segments, and
each of the plurality of mesh segments represents at least one region of interest in the base mesh.

4. The method of claim 1, further comprising:
generating, by the at least one processor, a quantized base mesh; and
encoding, by the at least one processor, the quantized base mesh to the bitstream using a static-mesh encoder.

5. The method of claim 1, wherein the generating, by the at least one processor, the plurality of binarized wavelet-transform coefficients based on the plurality of wavelet-transform coefficients comprises:
generating a fixed-point representation of the plurality of wavelet-transform coefficients; and
applying an exponential-Golomb code to the fixed-point representation of the plurality of wavelet-transform coefficients to generate the plurality of binarized wavelet-transform coefficients.

6. The method of claim 1, wherein the plurality of wavelet-transform coefficients are binarized at a slice-level, a picture-level, or a sequence-level.

7. The method of claim 1, wherein:
the plurality of binarized wavelet-transform coefficients are encoded into the bitstream using an entropy encoder, and
the entropy encoder includes one or more of a bypass encoder or a context-adaptive encoder.

8. An encoder for encoding a mesh, comprising:
at least one processor; and
memory storing instructions, which when executed by the at least one processor, cause the at least one processor to perform the method according to claim 1.

9. A method for decoding a mesh, comprising:
decoding, by at least one processor, a base mesh from a bitstream;
generating, by the at least one processor, a subdivided mesh based on the base mesh;
decoding, by at least one processor, a plurality of binarized wavelet-transform coefficients associated with the subdivided mesh from the bitstream;
de-binarizing, by the at least one processor, the plurality of binarized wavelet-transform coefficients to generate a plurality of wavelet-transform coefficients;
applying, by the at least one processor, an inverse wavelet transform to the plurality of wavelet-transform coefficients to generate a plurality of mesh displacements; and
generating, by the at least one processor, a reconstructed mesh based on the plurality of mesh displacements and the subdivided mesh.

10. The method of claim 9, wherein:
the subdivided mesh includes a plurality of mesh segments, and
each of the plurality of mesh segments represents at least one region of interest in the base mesh.

11. The method of claim 10, wherein the de-binarizing, by the at least one processor, the plurality of binarized wavelet-transform coefficients to generate a plurality of wavelet-transform coefficients comprises:
converting a fixed-point representation of the plurality of wavelet-transform coefficients to a plurality of floating-point values; and
applying an exponential-Golomb code to the plurality of floating-point values of the plurality of wavelet-transform coefficients to de-binarize the plurality of binarized wavelet-transform coefficients.

12. The method of claim 9, wherein the plurality of binarized wavelet-transform coefficients are de-binarized at a slice-level, a picture-level, or a sequence-level.

13. The method of claim 9, wherein:
the plurality of binarized wavelet-transform coefficients are decoded from the bitstream using an entropy decoder.

14. A decoder for decoding a mesh, comprising:
at least one processor; and
memory storing instructions, which when executed by the at least one processor, cause the at least one processor to:
decode a base mesh from a bitstream;
generate a subdivided mesh based on the base mesh;
decode a plurality of binarized wavelet-transform coefficients associated with the subdivided mesh from the bitstream;
de-binarize the plurality of binarized wavelet-transform coefficients to generate a plurality of wavelet-transform coefficients;
apply an inverse wavelet transform to the plurality of wavelet-transform coefficients to generate a plurality of mesh displacements; and
generate a reconstructed mesh based on the plurality of mesh displacements and the subdivided mesh.

15-29. (canceled)

30. A non-transitory computer-readable medium, configured to store a bitstream generated by the method according to claim 1.
